(19) United States
(12) Patent Application Publication
(10) Pub. No.: US 2019/0037595 A1
(43) Pub. Date: Jan. 31, 2019

(54) MANAGING UNSCHEDULED UPLINK ACCESS

(71) Applicant: QUALCOMM Incorporated, San Diego, CA (US)

(72) Inventors: George CHERIAN, San Diego, CA (US); Hemanth SAMPATH, San Diego, CA (US); Vincent Knowles JONES IV, Redwood City, CA (US); Alfred ASTERJADHI, San Diego, CA (US); Abhishek Pramod PATIL, San Diego, CA (US)

(21) Appl. No.: 16/046,938

(22) Filed: Jul. 26, 2018

Related U.S. Application Data
(60) Provisional application No. 62/537,593, filed on Jul. 27, 2017.
(60) Provisional application No. 62/596,768, filed on Dec. 8, 2017.

(51) Int. Cl. H04W 74/08; H04W 74/04

(52) U.S. Cl. CPC H04W 74/08; H04W 74/04

(57) ABSTRACT

Example methods, apparatuses, and computer-readable mediums for wireless communication are provided. In one example, a first device may be configured to determine whether to allow unscheduled access to the first device by a second device. The first device may be configured to transmit, based on the determination, first information to the second device. The first information may include a first indication indicative of whether the second device is allowed to transmit to the first device outside of a scheduled access period, or a second indication indicative of whether the second device is allowed to transmit to the first device without first receiving a trigger.

### CROSS-REFERENCE TO RELATED APPLICATION(S)

This application claims the benefit of U.S. Provisional Application Ser. No. 62/537,595, entitled “MANAGING UNSCHEDULED UPLINK ACCESS” and filed on Jul. 27, 2017, and U.S. Provisional Application No. 62/596,768, entitled “MANAGING UNSCHEDULED UPLINK ACCESS” and filed on Dec. 8, 2017, which are expressly incorporated by reference herein in their entirety.

### BACKGROUND

### Field

The present disclosure relates generally to communication systems, and more particularly, to managing access to wireless resources.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (such as circuit switching vs. packet switching), the type of physical media employed for transmission (such as wired vs. wireless), and the set of communication protocols used (such as Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices disclosed herein each have several aspects, no single one of which is solely responsible for the desirable attributes. Without limiting the scope of the innovative aspects as expressed by the claims which follow, some features will now be discussed briefly. After considering this discussion, and particularly after reading the section entitled “Detailed Description,” a person having ordinary skill in the art will understand how the various features described herein provide advantages for devices in a wireless network.

Various aspects related to association and operation in a 6 GHz band (also referred to herein as 6G) are described herein. WiFi devices may currently operate on a set of available frequency bands including, such as 2.4 GHz, 5 GHz, 900 MHz, 60 GHz. The 6 GHz band is expected to become available for operation of a next generation of devices including Wi-Fi and Cellular devices (such as LTE on unlicensed spectrum). In some examples, operation in one or more frequency bands (such as the 6 GHz band) may be fully scheduled (such as by a scheduling entity). In an 802.11 compliant system with an access point (AP) and client devices, the scheduling entity may be the AP. As such, the client devices (such as stations (STAs)) can transmit when scheduled by the scheduling entity. In other examples, operation in one or more frequency bands (such as the 6 GHz band) may be unscheduled. In such examples, the client devices (such as STAs) can transmit even when unscheduled by the scheduling entity.

One aspect of this disclosure provides an apparatus (such as an access point or a station) for wireless communication. The apparatus may be configured to determine a virtual medium access control (MAC) address based on a subset of MAC addresses of a set of MAC addresses associated with radios of the apparatus. In some implementations, each MAC address of the set of MAC addresses is associated with a different radio of the radios of the apparatus. The apparatus may be further configured to generate a secure key through an association procedure that is based on the determined virtual MAC address. The apparatus is further configured to communicate, using the generated secure key, through a plurality of radios on a plurality of different frequency bands, the plurality of radios being associated with the subset of MAC addresses.

Another aspect of this disclosure provides an apparatus (such as an access point or a station) for wireless communication. The apparatus may be configured to generate a secure key through an association procedure that is based on a plurality of MAC addresses associated with radios of the apparatus, and communicate, using the generated secure key, through the radios on a plurality of different frequency bands.

In another configuration, an apparatus for wireless communication may be configured to generate a secure key through an association procedure that is based on a MAC address associated with a first radio of a plurality of radios of the apparatus, the first radio being associated with a first frequency band of a plurality of frequency bands. The apparatus may be further configured to communicate, using the generated secure key, through a second radio of the plurality of radios on a second frequency band of the plurality of frequency bands.

Another aspect of this disclosure provides an apparatus for wireless communication. The apparatus may be configured to determine whether to allow unscheduled uplink (UL) access to the apparatus by a second device. The unscheduled access may include allowance of at least one UL transmission from the second device to the apparatus that is not solicited by the apparatus. The apparatus may, based on the determination, be configured to disallow unscheduled UL access to the apparatus, or allow unscheduled UL access to the apparatus within a first window.

Another aspect of this disclosure provides an apparatus for wireless communication. The apparatus may be configured to receive information indicative of an unscheduled UL access window. The information indicative of the unscheduled UL access window may include at least one of: a start time corresponding to the unscheduled UL access window, a duration of the unscheduled UL access window, or an end time corresponding to the unscheduled UL access window. The apparatus may be configured to perform an enhanced distributed channel access (EDCA) countdown only during the unscheduled UL access window. The apparatus may be configured to transmit unscheduled UL data to a second device in response to the EDCA countdown reaching a first value during the unscheduled UL access window.

Another aspect of this disclosure provides a first apparatus for wireless communication. The first apparatus may be configured to determine to allow unscheduled uplink (UL) access to the first apparatus by a second apparatus. The unscheduled UL access may include allowance of at least one UL transmission from the second apparatus to the first apparatus that is not solicited by the first apparatus. The first apparatus may be configured to transmit, in response to determining to allow unscheduled UL access to the first apparatus by the second apparatus, a first parameter set associated with a first enhanced distributed channel access (EDCA) mode and a second parameter set associated with a second EDCA mode. The first parameter set may include information indicative of start time of a first unscheduled UL access window at which the second apparatus is to use the first parameter set and the second parameter set comprises information indicative of a start time of a second unscheduled UL access window at which the second apparatus is to use the second parameter set.

Another aspect of this disclosure provides a first apparatus for wireless communication. The first apparatus may be configured to transmit a request to a second apparatus to allow unscheduled uplink (UL) access by the first apparatus to the second apparatus. The unscheduled UL access may include allowance of at least one UL transmission from the first apparatus to the second apparatus that is not solicited by the second apparatus. The first apparatus may be configured to receive a first parameter set associated with a first enhanced distributed channel access (EDCA) mode and a second parameter set associated with a second EDCA mode. The first parameter set may include information indicative of a start time of a first unscheduled UL access window at which the first apparatus is to use the first parameter set and the second parameter set may include information indicative of a start time of a second unscheduled UL access window at which the first apparatus is to use the second parameter set.

Another aspect of this disclosure provides a first device for wireless communication. The first device may be configured to determine whether to allow unscheduled access to the first device by a second device. The first device may be configured to transmit, based on the determination, first information to the second device. The first information may include a first indication indicative of whether the second device is allowed to transmit to the first device outside of a scheduled access period, or a second indication indicative of whether the second device is allowed to transmit to the first device without first receiving a trigger.

Another aspect of this disclosure provides a first device for wireless communication. The first device may be configured to receive first information from a second device. The first information may include a first indication indicative of whether the first device is allowed to transmit to the second device outside of a scheduled access period, or a second indication indicative of whether the first device is allowed to transmit to the second device without first receiving a trigger from the second device. Based on the first information, the first device may be configured to transmit second information to the second device, or refrain from transmitting the second information to the second device.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 shows an example wireless communication system in which aspects of the present disclosure may be employed.

FIG. 2 shows an example of an authentication process and messages exchanged during a 4-way handshake that may be performed as part of the authentication process according to some implementations.

FIG. 3 is a flowchart showing an example method of wireless communication of an apparatus according to some implementations.

FIG. 4 is a flowchart showing an example method of wireless communication of an apparatus according to some implementations.

FIG. 5 is a flowchart showing an example method of wireless communication of an apparatus according to some implementations.

FIG. 6 is a flowchart showing an example method of wireless communication of an apparatus according to some implementations.

FIG. 7A is a flowchart showing an example method of managing unscheduled uplink access according to some implementations.

FIG. 7B is a flowchart showing an example method of managing unscheduled uplink access according to some implementations.

FIG. 7C is a flowchart showing an example method of managing unscheduled uplink access according to some implementations.

FIG. 7D is a flowchart showing an example method of managing unscheduled uplink access according to some implementations.

FIG. 7E is a flowchart showing an example method of managing unscheduled uplink access according to some implementations.

FIG. 8 shows a functional block diagram of an example wireless communication apparatus.

### DETAILED DESCRIPTION

Various aspects of the novel systems, apparatuses, computer-readable media, and methods are described more fully hereinafter with reference to the accompanying drawings. The innovative aspects may, however, be embodied in many different forms and should not be construed as limited to any specific structures or functions presented throughout this disclosure. Rather, these aspects are provided so that this disclosure will be thorough and complete, and will fully convey the scope of the disclosure to enable persons having ordinary skill in the art to practice the innovative aspects. Based on the teachings herein, persons having ordinary skill in the art should appreciate that the scope of the disclosure is intended to cover any aspects of the innovative systems, apparatuses, computer program products (such as computer-readable media), and methods disclosed herein, whether implemented independently of, or combined with, any other aspects of the disclosure. For example, an apparatus may be implemented or a method may be practiced using any number of the aspects set forth herein. In addition, the scope of the disclosure is intended to cover such an apparatus or method which is practiced using other structures or functionalities in addition to or other than the various aspects set forth herein. Any aspect disclosed herein may be embodied by one or more elements of a claim.

Although particular aspects are described herein, many variations and permutations of these aspects fall within the scope of this disclosure. Although some benefits and advantages of particular aspects are described, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following detailed description. While the detailed description and drawings are illustrative of the disclosure, they are not limiting.

Popular wireless network technologies may include various types of wireless local area networks (WLANs). A WLAN may be used to interconnect nearby devices together, employing widely used networking protocols. The various aspects described herein may apply to any communication standard or wireless protocol.

In some aspects, wireless signals may be transmitted according to an IEEE 802.11 standard protocol using orthogonal frequency-division multiplexing (OFDM), direct-sequence spread spectrum (DSSS) communications, or a combination of OFDM and DSSS communications, or other schemes. Implementations of the 802.11 protocol may be used for sensors, metering, and smart grid networks. Advantageously, aspects of some devices implementing the 802.11 protocol may consume less power than devices implementing other wireless protocols, or may be used to transmit wireless signals across a relatively long range, for example, about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (such as IEEE 802.11 protocol) compliant wireless link to obtain general connectivity to the Internet or to other wide area networks. In some implementations a STA may also be used as an AP. In this regard, a STA may be described as a virtual AP (which may also be referred to as an AP STA) or a non-AP STA.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile device, a mobile station, a remote station, a remote terminal, a user terminal, a user agent, a user device, a user equipment (UE), or some other terminology. In some implementations, a station may comprise a cellular telephone, a “smartphone,” a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (such as a cellular phone or smartphone), a computer (such as a laptop), a portable communication device, a headset, a portable computing device (such as a personal data assistant), an entertainment device (such as a music or video device, or a satellite radio), a gaming device or system, a global positioning system (GPS) device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, the two apparatuses may be directly associated or intermediate apparatuses may be present. For purposes of brevity, the process for establishing an association between two apparatuses will be described using a handshake protocol that requires an “association request” by one of the apparatuses followed by an “association response” by the other apparatus. The handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of A, B or C” is intended to cover: A, B or C individually, or any combination thereof (such as A-B, A-C, B-C, or A-B-C).

As discussed above, some devices described herein may implement an IEEE 802.11 standard, for example, one or more of 802.11a, 802.11b, 802.11g, 802.11n, 802.11ac, 802.11ad, 802.11ah, 802.11ax, 802.11ay and 802.11az. Such devices, whether implemented as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (such as for use with hotspots), or to implement machine-to-machine communications.

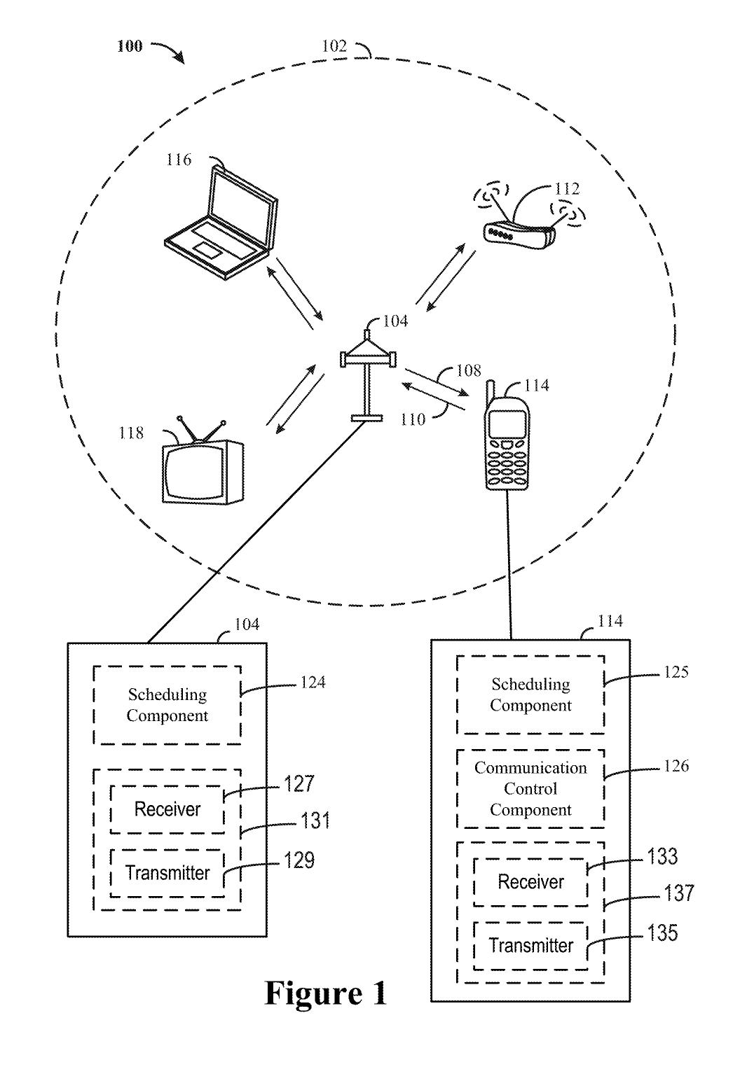

FIG. 1 shows an example wireless communication system 100 in which aspects of the present disclosure may be employed. The wireless communication system 100 may operate pursuant to a wireless standard such as, for example, those described above. The wireless communication system 100 may include an AP 104, which communicates with STAs (such as STAs 112, 114, 116, and 118).

A variety of processes and techniques may be used for the transmission and reception of communications in the wireless communication system 100 between the AP 104 and the STAs, as well as directly between STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (such as the BSA 102) is the coverage area of an AP (such as the AP 104). The AP 104 along with the STAs associated with the AP 104 that use the AP 104 for communication may be referred to as a basic service set (BSS). It should be noted that the wireless communication system 100 may not have a scheduling AP (such as AP 104), but rather may function as a peer-to-peer network between the STAs. Accordingly, the functions of the AP 104 described herein may alternatively be performed by one or more of the STAs.

The AP 104 may transmit on one or more channels (such as multiple narrowband channels, each channel including a frequency bandwidth) a beacon signal (or simply a “beacon”), via a communication link, such as the downlink 108, to other nodes (STAs) of the wireless communication system 100. The beacons may help the other nodes (STAs) to synchronize their clocks with the AP 104, as well as provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (such as shared) amongst several devices and specific to a given device.

In some aspects, a STA (such as STA 114) may be required to associate with the AP 104 to send communications to and receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

Various aspects related to association and operation in a 6 GHz band (which may also be referred to as 6G) are described herein. WiFi devices may currently operate on a set of available frequency bands including one or more of, for example, 2.4 GHz, 5 GHz, 900 MHz, or 60 GHz. The 6 GHz band is expected to become available for operation of a next generation of devices including Wi-Fi and Cellular devices (such as LTE on unlicensed spectrum). In some examples, operation in one or more frequency bands (such as the 6 GHz band) may be fully scheduled (such as by a scheduling entity). In an 802.11 compliant system with an access point (AP) and client devices, the scheduling entity may be the AP. As such, the client devices (such as STAs) can transmit when scheduled by the scheduling entity. In other examples, operation in one or more frequency bands may be unscheduled. In such examples, the client devices (such as STAs) can transmit even when unscheduled by the scheduling entity.

Generally, the AP 104 (or the STA 114 in another aspect) may include one or more components for performing various functions. The AP 104 includes a receiver 127 and a transmitter 129. The receiver 127 may be configured to perform any receiving function described herein. The transmitter 129 may be configured to perform any transmitting function described herein. The receiver 127 and the transmitter 129 may be combined into a transceiver 131.

For example, the AP 104 (or the STA 114 in another aspect) may include a scheduling component 124 to perform procedures related to one or more scheduling techniques described herein. As an example, the scheduling component 124 may be configured to perform scheduling of associated clients, such as stations associated with the AP 104, for medium access and/or allocation of resources for communication. In some configurations, the scheduling of associated devices for medium access may include scheduling for access of the 6 GHz frequency band. As another example, the scheduling component 124 may be configured to manage unscheduled uplink access in accordance with one or more techniques described herein. In some examples, the AP 104 may be configured perform any technique described in this disclosure (including any combination of techniques described in this disclosure).

Generally, the STA 114 may include one or more components for performing various functions. For example, the STA 114 may include a communication control component 126 to perform procedures related to authentication and association with the AP 104, to establish secure key(s) and to communicate over the available frequency bands, for example, one or more of the 2.4 GHz, 5 GHz, 6 GHz or other available bands.

In some examples, the STA 114 may include a scheduling component 125 to perform procedures related to one or more scheduling techniques described herein. The STA 114 also includes a receiver 133 and a transmitter 135. The receiver 133 may be configured to perform any receiving function described herein. The transmitter 135 may be configured to perform any transmitting function described herein. The receiver 133 and the transmitter 135 may be combined into a transceiver 137. In some examples, the scheduling component 125 may be configured to operate in the same manner as the scheduling component 124 of the AP 104, except that the scheduling component is a component of the STA 114. As an example, the scheduling component 125 may be configured to perform scheduling of associated clients, such as stations associated with the STA 114 (such as when the STA 114 is serving as a virtual AP or “hotspot”), including the scheduling of medium access or allocation of resources for communication. In some configurations, the scheduling of associated devices for medium access may include scheduling for access of the 6 GHz frequency band. As another example, the scheduling component 125 may be configured to manage unscheduled uplink access in accordance with one or more techniques described herein. In some examples, the STA 114 may be configured perform any technique described in this disclosure (including any combination of techniques described in this disclosure).

As set forth in more detail herein, unscheduled access generally refers to access that occurs outside of a scheduled access period. In some examples, an unscheduled access period (such as an unscheduled UL access window) may refer to any time outside of a scheduled access period. In some examples, an unscheduled access period may be a period of time that is outside of a scheduled access period. The period of time in such examples may be a window that has a specified length of time, the window being outside of the scheduled access period. For example, the unscheduled access period may be between two scheduled access periods; and, as such, the time between the two scheduled access periods may be referred to as an unscheduled access period. A scheduled access period may be, for example, a target wake time (TWT) window. Similarly, scheduled access generally refers to access that occurs within a schedule access period or is solicited. Scheduled access may be solicited via a trigger, such as a trigger frame or any other triggering information. The techniques described herein enable management of unscheduled and scheduled access.

For example, as described in more detail herein, an AP (such as AP 104) may be configured to determine whether to allow unscheduled access to the AP by a STA (such as STA 114). The AP 104 may be configured to transmit, based on the determination, first information to the STA. In some examples, the first information may include a first indication indicative of whether the STA is allowed to transmit to the AP outside of a scheduled access period, or a second indication indicative of whether the STA is allowed to transmit to the AP without first receiving a trigger. In some examples, the scheduled access period may include a TWT window.

In some examples, the first indication indicative of whether the STA is allowed to transmit to the AP outside of the scheduled access period may be indicative that the STA is allowed to transmit to the AP outside of the scheduled access period. In such examples, the AP may be configured to receive second information from the STA outside of the scheduled access period.

In some examples, the first indication indicative of whether the STA is allowed to transmit to the AP outside of the scheduled access period may be indicative that the STA is not allowed to transmit to the AP outside of the scheduled access period. In such examples, the AP may only receive transmissions from the STA during the scheduled access period.

In some examples, the second indication indicative of whether the STA is allowed to transmit to the AP without first receiving the trigger may be indicative of whether the STA is allowed to transmit to the AP during the scheduled access period without first receiving the trigger. In such examples, the AP may be configured to receive, without transmission of a trigger to the STA, second information from the STA during the scheduled access period. The second information may be any information transmitted by the STA.

In some examples, the second indication indicative of whether the STA is allowed to transmit to the AP without first receiving the trigger may be indicative that the STA is not allowed to transmit to the AP during the scheduled access period without first receiving the trigger. In such examples, the AP may be configured to transmit a trigger to the STA to solicit information from the STA, such as second information. Without receiving the trigger, the STA is not allowed to transmit to the AP during the scheduled access period. After transmitting the trigger, the AP may be configured to receive second information from the STA during the scheduled access period. The second information may be any information transmitted by the STA.

In some examples, to determine whether to allow unscheduled access to the AP by the STA, the AP may be configured to determine whether to allow unscheduled access to the AP by the STA in a first band. In some examples, the first band may be the same as an operating band of a BSS to which the AP belongs. In other examples, the first band may be a different operating band than the BSS to which the AP belongs.

As another example, as described in more detail herein, a STA (such as STA 114) may be configured to receive first information from an AP (such as AP 104). The first information may include a first indication indicative of whether the STA is allowed to transmit to the AP outside of a scheduled access period, or a second indication indicative of whether the STA is allowed to transmit to the AP without first receiving a trigger from the AP. Based on the first information, the STA may be configured to transmit second information to the AP, or refrain from transmitting the second information to the AP. The second information may be any information. In some examples, the scheduled access period may include a TWT window.

In some examples, the first indication indicative of whether the STA is allowed to transmit to the AP outside of the scheduled access period may be indicative that the STA is allowed to transmit to the AP outside of the scheduled access period. In such examples, the STA may be configured to transmit second information to the AP outside of the scheduled access period. Otherwise described, if the STA receives such a first indication, the STA may then transmit second information to the AP outside of the scheduled access period because of having received the first indication.

In some examples, the first indication indicative of whether the STA is allowed to transmit to the AP outside of the scheduled access period may be indicative that the STA is not allowed to transmit to the AP outside of the scheduled access period. In such examples, the STA may be configured to refrain from transmitting second information to the AP outside of the scheduled access period because of having received the first indication.

In some examples, the second indication indicative of whether the STA is allowed to transmit to the AP without first receiving the trigger may be indicative of whether the STA is allowed to transmit to the AP during the scheduled access period without first receiving the trigger. In such examples, based the second indication, the STA may be configured to transmit, without first receiving a trigger (such as a trigger frame) from the AP, second information to the AP during the scheduled access period.

In some examples, the second indication indicative of whether the STA is allowed to transmit to the AP without first receiving the trigger may be indicative that the STA is not allowed to transmit to the AP during the scheduled access period without first receiving the trigger. In such examples, the STA may be configured to refrain from transmitting second information to the AP during the scheduled access period unless the STA receives a trigger (such as a trigger frame) from the AP. For example, the STA may be configured to receive a trigger from the AP. The STA may then transmit second information to the AP during the scheduled access period in response to the receiving the trigger.

In some examples, the first indication indicative of whether the STA is allowed to transmit to the AP outside of the scheduled access period may be indicative of whether the STA is allowed to transmit to the AP outside of the scheduled access period in a first band. In some examples, the first band may be the same as an operating band of a BSS to which the AP belongs. In other examples, the first band may be a different operating band than the BSS to which the AP belongs.

In some examples, the second indication indicative of whether the STA is allowed to transmit to the AP without first receiving the trigger from the AP may be indicative of whether the STA is allowed to transmit to the AP in a first band without first receiving a trigger from the AP. In some examples, the first band may be the same as an operating band of a BSS to which the AP belongs. In other examples, the first band may be a different operating band than the BSS to which the AP belongs.

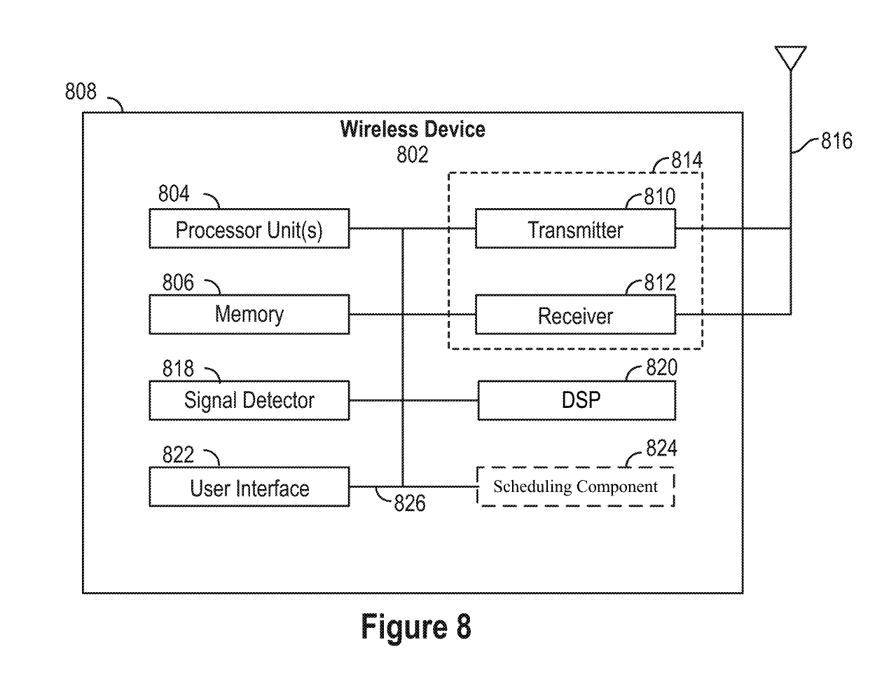

A first device (such as AP 104, STA 114, wireless device 802, or any other device configured to perform one or more techniques described herein) is disclosed that includes one or more components for performing various functions. In some implementations, the first device is a device as described with reference to FIG. 1. In some other implementations, the first device is a device as described with reference to FIG. 8. In accordance with the techniques described herein, the first device may be configured to enable a fully scheduled mode in which the first device operates as the scheduling entity. For example, the first device may be configured to solicit uplink traffic from one or more second devices. In some such implementations, the first device may be an AP or an AP STA and the one or more second devices may be non-AP STAB.

Enabling a fully-scheduled mode may have practical issues such as availability of an efficient buffer-status feedback, dependency on a scheduling entity, or dependency on AP scheduling. In some examples, unscheduled uplink access may unnecessarily consume bandwidth. In accordance with one or more techniques described herein, the first device may be configured to manage unscheduled uplink access. Unscheduled uplink access may refer to STA-initiated (such as non-AP STA-initiated) uplink access. STA-initiated uplink access may include transmission of an uplink frame by a STA to an AP that was not solicited by the AP, such as by a trigger frame. Because the uplink transmission was not solicited by the AP (that is, because the uplink transmission was initiated by the STA), the uplink transmission may be considered unscheduled. In some examples, the unscheduled uplink access described herein may refer to single-user (SU) unscheduled uplink access.

In some examples, the first device (when configured to operate as an AP) may be configured to disallow non-AP STA-initiated unscheduled uplink access when another AP is operating in the vicinity of the first device with a fully scheduled operation. In such examples, the first device may be configured to disallow unscheduled uplink access according to one or more techniques described herein.

In one example, the first device may be configured to transmit a channel availability query (CAQ) to the one or more second devices (such as APs and/or STAs) to determine channel availability. The one or more second devices may be configured to transmit a CAQ response that includes information indicative of channel availability or information indicative of the type of access allowed for a channel. The type of access allowed for the channel may include scheduled-only access, unscheduled access, or scheduled and unscheduled access. Scheduled-only access is a type of access that indicates that unscheduled access is not available on the channel (that is, only scheduled access is allowed on the channel). Unscheduled access is a type of access that indicates that unscheduled uplink access is allowed on the channel. Scheduled and unscheduled access is a type of access that indicates that scheduled and unscheduled uplink access is allowed on the channel. In some examples, the type of access may indicate that (1) unscheduled uplink access is allowed or (2) unscheduled uplink access is disallowed.

In some examples, the first device may be configured to receive a CAQ response from each of the one or more second devices. The first device may be configured to disallow (such as shutdown or disable) unscheduled uplink access based on a received CAQ response. For example, the first device may be configured to disallow unscheduled uplink access to the first device over each channel identified in any received CAQ response that includes information indicating that unscheduled uplink access is disallowed.

In another example, the first device (when configured to operate as an AP) may be configured to manage (such as control) unscheduled uplink access based on whether one or more neighboring devices (such as APs) allow or disallow unscheduled uplink access. For example, if a neighboring device does not allow unscheduled uplink access, the first device may be configured to disallow unscheduled uplink access. As another example, if a neighboring device does allow unscheduled uplink access, the first device may be configured to allow unscheduled uplink access. As a further example, the first device may be configured to manage unscheduled uplink access by monitoring overlapping basic service set (OBSS) beacon frames sent to the first device from the one or more neighboring devices. The OBSS beacon frame may include information indicating whether the neighboring device that sent the OBSS beacon frame does or does not allow unscheduled uplink access. For example, the first device may be configured to disallow unscheduled uplink access if a neighboring device is operating in scheduled-only mode or otherwise does not allow unscheduled uplink access.

In other examples, the first device (when configured to operate as an AP) may be configured to limit (such as control) or otherwise reduce unscheduled uplink access. By limiting unscheduled uplink access, the first device may be configured to allow both scheduled and unscheduled uplink access. For example, the limited unscheduled uplink access may not negatively impact scheduled access efficiency whereas unlimited (such as uncontrolled) unscheduled uplink access may negatively impact scheduled access efficiency. For example, without limiting unscheduled uplink access, bandwidth may be consumed by unscheduled uplink transmissions to a point where there is not enough bandwidth for the scheduled uplink transmission.

In some examples, the first device may be configured to limit unscheduled uplink access to a duration of time, which may also be referred to as a window. In some examples, the duration of time (or window) may be a target wake time (TWT) included in a field of a TWT element. As such, the window during which unscheduled uplink access may occur may be referred to as a TWT window in some examples. In some examples, the TWT window (such as the time of the window) may be defined as a service period (SP) in the TWT element.

In some examples, the TWT element includes an access type field. The access type field may include information indicative of a type of access allowed by the first device. The type of access allowed by the first device may include scheduled-only access, unscheduled access, or scheduled and unscheduled access. The type of access may indicate that (1) unscheduled uplink access is allowed or (2) unscheduled uplink access is disallowed. In some examples, the type of access field in the TWT element may have a length. The length may be one or more bits, depending on the specific implementation. For example, a 1-bit type of access field may include a first value indicating that unscheduled access is allowed or a second value indicating that unscheduled access is not allowed.

The first device may be configured to transmit information (such as a first indication or a second indication described above) indicating whether unscheduled uplink access is or is not allowed to the one or more second devices. Based on the information received from the first device, the one or more second devices may be configured to not send unscheduled uplink transmissions to the first device when unscheduled uplink access is not allowed. Similarly, based on the information received from the first device, the one or more second devices may be configured to send unscheduled uplink transmissions to the first device when unscheduled uplink access is allowed. In this way, the first device may be configured to inform the one or more second devices to transmit or not transmit unscheduled uplink transmissions (which may be referred to as uplink frames, uplink packets, or the like).

For example, the first device may be configured to transmit the TWT element including the access type field to the one or more second devices. Based on the information in the access type field of the TWT element, the one or more second devices may be configured to not send unscheduled uplink transmissions to the first device when the information in the access type field indicates that unscheduled uplink access is not allowed. Similarly, based on the information in the access type field of the TWT element, the one or more second devices may be configured to send unscheduled uplink transmissions to the first device when the information in the access type field indicates that unscheduled uplink access is allowed. In some examples, the one or more second devices may be configured to send (such as transmit) unscheduled uplink transmissions only during the TWT window. In other examples, each of the one or more second devices may be configured to perform an enhanced distributed channel access (EDCA) countdown during the TWT window. In such examples, the EDCA countdown performed by each of the one or more second devices may prevent or reduce collisions by distributing unscheduled uplink access transmissions over the duration of the TWT window. For example, without the EDCA countdown, each of the second devices may attempt to transmit an unscheduled uplink transmission to the first device at the same time (such as when the TWT window starts), which may result in numerous collisions.

As described herein, in some examples, the first device may be configured to limit unscheduled uplink access to a duration of time, which may also be referred to as a window. In some examples, the duration of time (or window) may be included in an information element different from the TWT element. Information indicative of the window, such as, for example, a start time, a duration of the window, and an end time, may be included in a field or information element in a beacon frame. For example, the beacon frame may include a new information element (IE) that includes information indicative of the window (that is, the window during which unscheduled uplink access is allowed). In some examples, the beacon frame may be a beacon report. In such an example, the beacon report may include information indicative of the window.

The first device may be configured to transmit the beacon frame including information indicative of the window to the one or more second devices. Based on the information in the beacon frame, the one or more second devices may be configured to send unscheduled uplink transmissions to the first device during the window identified in the beacon frame. Each of the one or more second devices may be configured to perform an enhanced distributed channel access (EDCA) countdown during the window. In such examples, the EDCA countdown performed by each of the one or more second devices may prevent or reduce collisions by distributing unscheduled uplink access transmissions over the duration of the window. For example, without the EDCA countdown, each of the second devices may attempt to transmit an unscheduled uplink transmission to the first device at the same time (such as when the window identified in the beacon frame starts), which may result in numerous collisions. As used herein, the window during which unscheduled uplink access is allowed may be referred to as an unscheduled uplink access window in that the window defines when unscheduled uplink access may occur.

In examples where multiple APs are present in a network (such as where the first device is an AP and at least one of the one or more second devices is also an AP), scheduled and unscheduled uplink access times may be aligned. In such examples, an AP of the network may be configured to coordinate the unscheduled uplink access window for further optimization. For example, the first device (or another AP in the network) may be configured to advertise the unscheduled uplink access window by transmitting information indicative of the unscheduled uplink access window to other APs so that OBSS APs can align scheduled and unscheduled uplink access. In some examples, the information indicative of the unscheduled uplink access window may be transmitted in accordance with one or more techniques described herein. For example, the information indicative of the unscheduled uplink access window may be transmitted in a TWT element or a beacon frame. OBSS APs may be configured to obtain the unscheduled uplink access window from a received TWT element or a received beacon frame. In some examples, the information indicative of the unscheduled uplink access window may be unicasted to other APs. In other examples, the information indicative of the unscheduled uplink access window may be broadcasted to other APs.

To advertise the unscheduled uplink access window to other APs, the advertising AP (that is, the AP configured to advertise the window) may be configured as the leader, advertiser, or other like term. For example, in a managed network, an AP may be configured by an operator to be the leader or advertiser. As another example, one AP among a plurality of APs may be elected as the leader or advertiser. In some examples, this election process may occur in a round robin manner. In some examples, the election process may be random, meaning that each AP in the plurality of APs has an equal opportunity of being elected as the leader or advertiser. In other examples, this election process may be based on one or more criteria. In such examples, the one or more criteria may include traffic. In this example, the AP among the plurality of APs with the most unscheduled uplink traffic may be elected as the leader or advertiser.

Until new technologies (such as the next generation Wi-Fi and/or 5G cellular) become available and start using the 6 GHz band, it is contemplated that 802.11ax devices can operate on the 6 GHz band. Because the 6 GHz band is a new band, some implementations would enable greenfield operation (that is, no need to support legacy devices). This means that many of the MAC inefficiencies required to support legacy operation may not be required. Further, 802.11ax has introduced several techniques for enabling AP-controlled operation (such as scheduled access instead of contention-based medium access). Such enhancement can greatly improve the system throughput. 802.11ax devices that support operations in 6 GHz would signal their support either via a bit or a field in a Capabilities element (such as HE Capabilities) or via an Operation element (such as HE Operation element). In addition, in accordance with one aspect, 802.11ax client devices operating in the 6 GHz band may be mandated to operate in fully scheduled mode. An AP may set up at least one TWT (Target Wake Time) service period (SP) during which STAs would wake up to be serviced by the AP. During TWT SPs, the AP can send downlink (DL) traffic to STAs or send trigger frames (TFs) to solicit uplink (UL) traffic from the STAs. STAs may also include buffer status report (BSR) to indicate to the AP the amount of UL traffic they have buffered. The AP may also send frequent TFs during the TWT-SP to solicit BSR from the STAs. In such implementations, non-AP STAs may not access the medium in the 6 GHz band unless scheduled by an AP (that is, EDCA will be disabled and STAs always wait for TF from the AP). Further, in accordance with an aspect, unassociated STAs may discover the AP in the 5 GHz band (such as by listening to an AP's Beacon), and after determining that the AP also operates in the 6 GHz band (based on the bit or field in HE Capabilities or HE Operation element), perform association on 6 GHz. In some other implementations, a STA may be configured to discover and associate with the AP on 5 GHz and transfer the session to 6 GHz. In such implementations, the STA may switch to 6 GHz after discovering the AP and wait for a TF containing Random Access Resource Units (RA-RUs) for unassociated STAs (RU with AID 2045). The unassociated STA can use the RA-RUs to send frames (such as probe requests, association requests, authentication request frames) to the AP to complete the association with the AP. In some configurations, the discovery and association may occur on 5 GHz while the authentication occurs on 6 GHz (frames sent using RA-RUs). While operating in 6 GHz, an AP may disable several legacy features including IBSS mode, EDCA (and other legacy channel access mechanisms), HT Delayed BA, DLS, PSMP unscheduled power save (PS Poll, UAPSD etc.), Operation outside the context of a BSS (OCB) etc.

In some implementations, an operator or a user also can have the capability to turn off or disable 802.11ax operations in 6 GHz. This may be achieved by disabling (such as setting to 0) or not including the bit or field that indicates support for operating on 6 GHz or by upgrading the firmware on the devices or via some other means. In some configurations, an AP may signal disabling operation on 6 GHz. In some other configurations, an AP may detect presence of other technologies on 6 GHz and disable operations on 6 GHz. In some other cases, an AP may disable operation on 6 GHz in response to detecting that one or more APs in the neighborhood have disabled operation on 6 GHz. An operator may choose to turn off 802.11ax operation on 6 GHz once new technologies are ready to use the 6 GHz band.

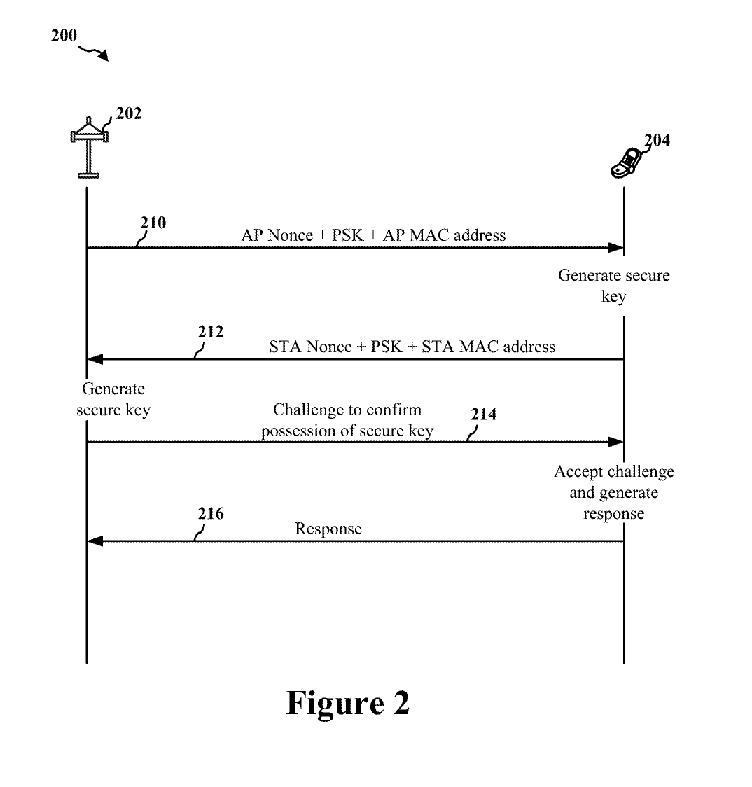

Before two devices, such as an AP and a station, can start communicating, the devices may need to establish their identity by following an authentication and association procedure. For example, a station may first establish its identity with an AP and then associate with the AP to gain access to the network and securely communicate with the AP and other devices in the network. FIG. 2 shows an example of an authentication process and messages exchanged during a 4-way handshake that may be performed as part of the authentication process according to some implementations. For example, FIG. 2 shows an example of an authentication process 200 that allows an AP 202 (which may be the authenticator in this example) and a wireless client 204 (such as a station) to establish their identities by independently proving to each other that they know the pre-shared key (PSK) or pairwise master key (PMK). In the process, the devices may generate another key, for example, a secure key, that is not exchanged or disclosed over the network. The secure key is then used by the devices to communicate (send/receive frames) with each other, such as for encrypting the frames being transmitted. In some configurations, the secure key may be generated by first determining a pairwise transient key (PTK) and then subjecting the PTK through a pseudo random function.

The illustrated example process 200 shows the messages exchanged during a 4-way handshake. The AP 202 may send a frame 210 including nonce-value to the STA. The frame 210 may further include a PSK/PMK and the MAC address of the AP 202. Additional parameters or attributes may be included in the frame as well. The station 204 receives the frame and obtains the attributes to determine a secure key. The station 204 then generates the secure key using the obtained information and an algorithm or mechanism agreed upon by the AP 202 and the station 204.

The station 204 then sends a frame 212 including its own nonce-value, the PSK/PMK and the MAC address of the station 204 (such as a MAC address corresponding to a radio component used for communicating with the AP 202). The frame 212 may also include a message integrity code (MIC) including authentication. The AP 202 receives the frame and obtains the attributes needed to generate the secure key at the AP 202. The AP 202 then generates the secure key using the obtained information and the algorithm or mechanism agreed upon by the AP 202 and the station 204. Next, the AP 202 sends a frame 214 including information to prompt the station 204 to verify that it has indeed generated the correct secure key but without actually transmitting the secure key over the wireless medium. The frame 214 may include a challenge that may be responded to only if the station 204 has successfully generated the secure key. In some configurations, the challenge may include a hash of the secure key generated by the AP 202. Assuming that the station 204 successfully generated the secure key, the station 204 may accept the challenge and successfully respond to the challenge by sending a response frame 216 that confirms to the AP 202 that station 204 is in possession of the secure key. Following the authentication, the station 204 may associate with the AP 202 and the AP 202 may grant the station 204 access to network, for example, by providing access to network resources for communication. In some configurations, the station 204 supports communications over the 6 GHz band and upon association the AP 202 may allow the device to communicate over the 6 GHz band, such as by scheduling the station 204 to use the 6 GHz band for transmitting and receiving.

While the implementations described with reference to FIG. 2 provide examples of an example authentication procedure, a variety of other authentication procedures (such as such as cloud based authentication via an authentication server) may be used for authentication.

WiFi devices may currently operate on a set of available frequency bands including, such as 2.4 GHz, 5 GHz, 900 MHz, 60 GHz bands. The 6 GHz band is expected to become available for operation of next generation of devices including Wi-Fi and Cellular devices. A common medium reservation scheme may be designed to broker access between inter and intra technologies. For instance, in an area there may exist a variety of devices operating using different radio access technologies (RATs) and there may be a common medium reservation mechanism that allows the devices to know who is controlling the medium (such as the 6 GHz band) at a given time. In the context of a WiFi system, if a WiFi AP gains access of the medium (such as for a given period of time), the AP may have full ownership of the medium for the time period and may fully control scheduling of associated client devices for use of the medium. Thus, medium access for Wi-Fi clients can be fully scheduled by their associated AP.

In an aspect, different modes of operation in the 6 GHz are considered, including: 6 GHz as standalone radio (single radio), 6 GHz as an additional radio (multi-radio), 6 GHz as an auxiliary radio (as an extension of 5 GHz, such as with additional channels in the 6 GHz band to the 5 GHz band). The following discussion focuses on various different alternatives for association and operation of devices when the 6 GHz band is used as an additional radio band, such as in addition to one or more other frequency bands being used by the devices for communication operations. In such a case the devices may include multiple different radios, such as wireless radio interfaces/modems, for communicating over different frequency bands including at least one radio for communicating via the 6 GHz band.

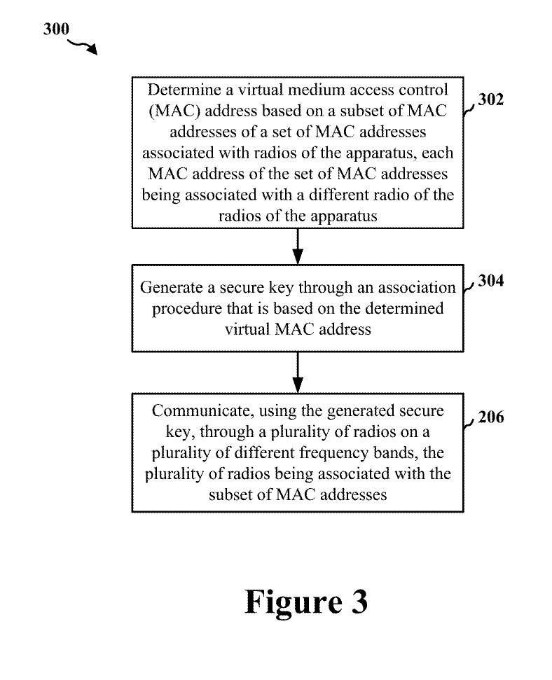

In an aspect, various association options may be considered. For example, in a WiFi device having multiple radios, one of the radios may operate on 6 GHz while the other(s) may operate on other available/supported bands (such as 5 GHz, 2.4 GHz, 900 MHz etc.). In one approach, three alternatives are considered: 1) Single authentication with a virtualized MAC address; 2) (a) Single authentication with both MAC addresses, and (b) with one MAC address; and 3) Dual authentication, such as authentication on each band. Each of the above options are discussed in more detail with reference to the flowcharts of FIGS. 3-6.

In the first option, a single authentication procedure may be performed using a virtual MAC address. It is considered that the devices have a plurality of radios (such as a different radio interface for each supported frequency band, and each radio having an associated MAC address). Devices (such as AP and Client/STA) may use a virtual MAC address for association and establishing a secure key. The virtual MAC address may be generated in a variety of ways as discussed below. Using the virtual MAC address, a secure key is then generated during the authentication process which is later used to communicate through the plurality of radios on a corresponding plurality of different frequency bands. Once the authentication and association is complete using the virtual MAC address, frames can be exchanged on any of the supported bands using the virtual MAC address that has been associated. Various aspects of the single authentication with a virtualized MAC address are discussed with respect to FIG. 3.

FIG. 3 is a flowchart showing an example method 300 of wireless communication according to some implementations. The method may be performed by an apparatus such as an access point (such as AP 104, 202) or a station (such as station 114, 204) or any of the other client devices shown and described with reference to FIG. 1. At block 302, the apparatus may determine a virtual MAC address based on a subset of MAC addresses of a set of MAC addresses associated with radios of the apparatus. Each MAC address of the set of MAC addresses may be associated with a different radio of the radios of the apparatus. For example, the apparatus (such as an AP or a station) may include 4 radios with at least one radio for the 6 GHz band, and the virtual MAC address may be generated based on the MAC addresses of all 4 radios or a subset (such as 2) of the MAC addresses of the radios. In one configuration, the virtual MAC address may be generated based on 48-n common bits of the subset of MAC addresses, where each MAC address includes 48 bits and n is the number of uncommon bits of the subset of MAC addresses. For example, the plurality of radios of the apparatus may be from the same vendor/manufacturer and there is a strong likelihood that the MAC addresses of the multiple radios differ from each by only a few (n) bits. In such a case, the virtual MAC address may be generated using 48-n common bits among the multiple MAC addresses being considered. In one example, the virtual MAC address may include 48-n common bits and the rest of the remaining bits of the virtual MAC address may be set to 0.

In one configuration, the virtual MAC address may be generated based on one or more MAC addresses of the subset of MAC addresses. For example, one of the radio's MAC address may be used as the virtual MAC address. In yet another configuration, the virtual MAC address may be generated as a function of certain inputs, such as MAC address of each radio. For example, the virtual MAC address may be generated based on a hash (or another function) of the subset of MAC addresses, such as using 2 MAC addresses (or another subset of MAC addresses) as inputs to a hash function and using the output of the hash as the virtual MAC address. In yet another configuration, the virtual MAC address may be generated using a random function.

As discussed with reference to FIG. 2, a secure key can be generated for exchanging frames between two communicating devices and the MAC address of the devices is used in the secure key generation. In one configuration, the secure key as described with reference to FIG. 3 may be generated based on the determined virtual MAC address. Thus, as shown, at block 304, the apparatus may generate a secure key through an association procedure that is based on the determined virtual MAC address. The generation of the secure key may further be based on a virtual MAC address generated by another device involved in the authentication and association process. For example, if the apparatus is an AP, the secure key may be generated based on virtual MAC address generated by the AP and further based on the virtual MAC address generated by a client device/station involved in the authentication and association process.

In accordance with an aspect, this generated secure key can be used for communication through the plurality of supported frequency bands including the 6 GHz band. At block 306, the apparatus may communicate, using the generated secure key, through the plurality of radios on the plurality of different frequency bands, where the plurality of radios are associated with the subset of MAC addresses (such as which are used to determine the virtual MAC address). In some configurations, the communicating comprises at least one of transmitting or receiving a frame using the generated secure key on each of the plurality of different frequency bands. In some configurations, the communicating comprises transmitting or receiving a first frame using the generated secure key on a first frequency band, such as a 5 GHz band, and transmitting or receiving a second frame using the generated secure key on a second frequency band of the plurality of different frequency bands, such as a 6 GHz band. In some configurations, the different frequency bands include a 6 GHz frequency band, and at least one other frequency band including a 5 GHz frequency band, a 2.4 GHz frequency band, or a 900 MHz frequency band.

Thus in the single authentication with a virtualized MAC address, a single authentication is performed and a single secure key determined based on the virtual MAC address may be used for communication over multiple different bands without having to generate different keys for communication over different bands, such as via different radios. Furthermore, the frames on any of the plurality of bands may use the virtual MAC address.

While in the above example, a single association-single key mechanism for use on all supported frequency bands (including the 6 GHz band) is described, other variants are possible. For example, there may be process with a single association (single AID) between the two devices (using the virtual MAC address) for all radios and all bands used for communication between the devices but with a separate secure key per band/link. That is, a different secure key may derived for each band/link. In such a configuration, for the derivation of a secure key for use in communicating over a given band/link, the actual physical MAC address of the radios used for the given band/link.

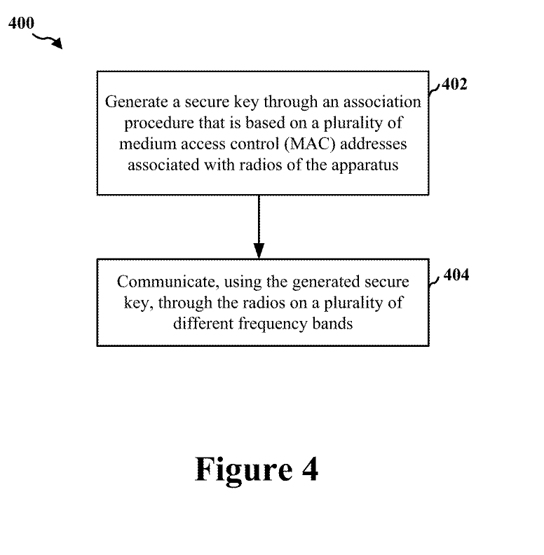

Next, consider the second alternative for association that uses a single authentication with both MAC addresses. Again, in this option a single authentication procedure may be performed using multiple MAC addresses. In this option, authentication and association scheme may be modified to consider multiple MAC addresses, e.g. corresponding to multiple radios of the device. In one configuration, the key generation algorithm may take the multiple MAC addresses as input. In some configurations, a single key generated using the multiple MAC addresses is valid on the multiple bands and a single association valid for the multiple band/links. The frames transmitted on each band may use the MAC address of the corresponding radio being used for transmission. Various aspects of this option are discussed with reference to FIG. 4.

FIG. 4 is a flowchart showing an example method 400 of wireless communication according to some implementations. The method may be performed by an apparatus such as an access point (such as AP 104, 202) or a station (such as station 114, 204) or any of the other client devices shown and described with reference to FIG. 1. At block 402, the apparatus may generate a secure key through an association procedure that is based on a plurality of MAC addresses associated with radios of the apparatus. For example, because the apparatus is assumed to include a plurality of radios each having a MAC address, in some configurations a plurality of MAC address corresponding to the plurality of radios may be used in the secure key generation operation. In accordance with an aspect, the secure key generated using the plurality of MAC addresses may be used for communication through the plurality of supported frequency bands including the 6 GHz band.

At block 404, the apparatus may communicate, using the generated secure key, through the plurality of radios on the plurality of different frequency bands. In some configurations, the communicating comprises at least one of transmitting or receiving a frame using the generated secure key on each of the plurality of different frequency bands. In some configurations, the communicating comprises transmitting or receiving a first frame using the generated secure key on a first frequency band, such as a 5 GHz band, and transmitting or receiving a second frame using the generated secure key on a second frequency band of the plurality of different frequency bands, such as a 6 GHz band. In some configurations, the different frequency bands include a 6 GHz frequency band, and at least one other frequency band including a 5 GHz frequency band, a 2.4 GHz frequency band, or a 900 MHz frequency band. Thus in this approach again, a single authentication is performed and a single secure key is generated, although the secure key is generated based on multiple MAC addresses. The single key may be used for communication over multiple different bands without having to generate different keys for communication over different bands, such as via different radios. In various configurations, the frames transmitted on each band may use the MAC address of the radio that corresponds to/associated with that band. For example, the frames transmitted over the 5 GHz band may use the MAC address of the radio associated with the 5 GHz band and the frames transmitted over the 6 GHz band may use the MAC address of the radio associated with the 6 GHz band.

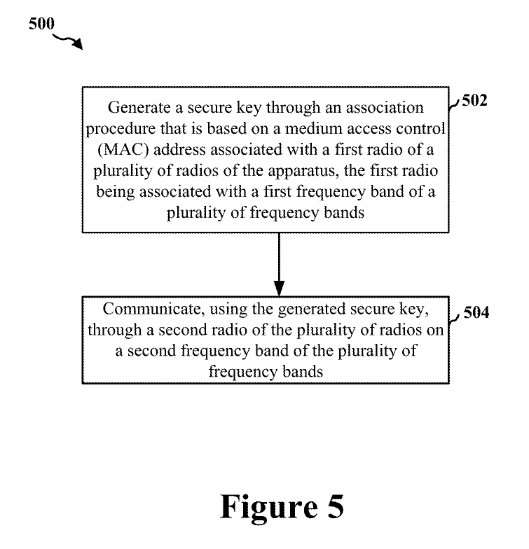

Next, consider a third alternative for association that includes a single association on one band and the same association information and secure key is simply carried over to one or more other supported frequency bands. In this option, a single authentication and association may be performed using a MAC addresses corresponding to one radio of a plurality of radios of the device. The devices involved in authentication and association (such as AP and station) may authenticate and associate on a single band while no association or authentication is performed on the other band. Rather, in an aspect, the same key and association information is carried over to the other band. For example, the devices establish secure association on 5 GHz band and use it for a link on the 6 GHz band. The frames transmitted on each band may use the MAC address of the radio that corresponds to or is associated with that band. Various aspects of this option are described below with reference to FIG. 5.

FIG. 5 is a flowchart showing an example method 500 of wireless communication according to some implementations. The method may be performed by an apparatus such as an access point (such as AP 104, 202) or a station (such as station 114, 204) or any of the other client devices shown and described with reference to FIG. 1. At block 502, the apparatus may generate a secure key through an association procedure that is based on a MAC addresses associated with a first radio of a plurality of radios of the apparatus, the first radio being associated with a first frequency band of a plurality of frequency bands. For example, the apparatus may perform authentication and association on a single, such as a 5 GHz band. In this example, the MAC address corresponding to a radio used for communication over the 5 GHz band may be used in the secure key generation operation. Once the apparatus is authenticated and associated on the 5 GHz band and the secure key generated, the secure key may be used for communication over the 5 GHz band as well as other bands.

At block 504, the apparatus may communicate, using the generated secure key, through a second radio of the plurality of radios on a second frequency band of the plurality of frequency bands. For example, as discussed above, the secure key may be generated based on a first MAC address corresponding to a first radio as part of the authentication and association in a first band, such as a 5 GHz band. While the secure key may be used to communicate over the 5 GHz band, in accordance with the method 500 described with reference to FIG. 5, the same secure key may be used for communicating over other bands, such as a 6 GHz band. Thus in this approach, the apparatus may establish secure association in a first band, such as a 5 GHz band, and use the secure association credentials and secure key for communicating over a second band, such as a 6 GHz band. The single secure key may be used for communication over multiple different bands without the devices having to associate on each of the different bands and generate different secure keys. In various configurations, the frames transmitted on each band may use the MAC address of the radio that corresponds to/associated with that band.

While in the above method 500 described with reference to FIG. 5 a single secure key generated as part of authentication and association over one band is used for communicating over another band, in a variant of this method, separate secure keys, such as temporary secure keys, may be derived for each other link even though only one full authentication and association procedure may be performed. For instance, in one particular variant of the method 500, the apparatus may authenticate and associate on a first (single) band, such as a 5 GHz band, however the apparatus may still generate a different key for communicating over another band, such as the 6 GHz band. In this variant, to generate the secure key for communicating over each different band, only a quick re-authentication, such as a quick handshake, on the other band may be performed rather than a full authentication and association as performed with respect to the first band. Subsequent to the quick handshake the apparatus may derive a secure key and use for communications over the second band.

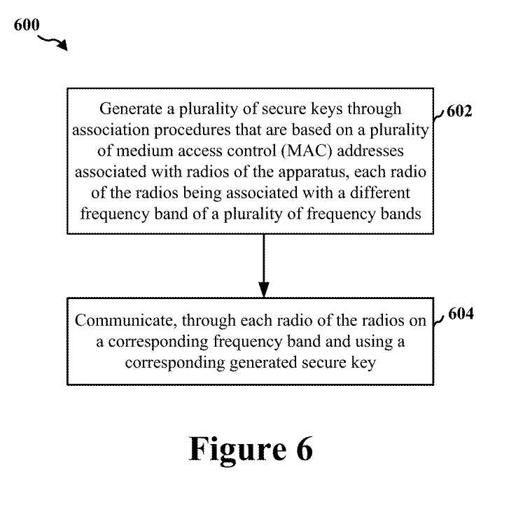

Now consider a fourth alternative for association that includes dual association, such as a separate association on each different band. In accordance with this option, the two devices involved in authentication and association establish separate associations on each band. When operating on a particular band, the association information and secure key generated for the specific band may be used for communication on that band. In such a configuration, frames transmitted on each band use the MAC address of that radio. Various aspects of the dual association option are described below with reference to FIG. 6.

FIG. 6 is a flowchart showing an example method 600 of wireless communication according to some implementations. The method may be performed by an apparatus such as an access point (such as AP 104, 202) or a station (such as station 114, 204) or any of the other client devices shown and described with reference to FIG. 1. At block 602, the apparatus may generate a plurality of secure keys through association procedures that are based on a plurality of MAC addresses associated with radios of the apparatus, each radio of the radios being associated with a different frequency band of a plurality of frequency bands. For example, the apparatus may include 2 radios corresponding to supported frequency bands, such as a first radio for a 5 GHz band and a second radio for the 6 GHz band. The device may perform authentication and association on the first, such as a 5 GHz band, generate a secure key specific to the 5 GHz band based on the MAC address of a radio corresponding to the 5 GHz band and use it to communicate over the 5 GHz band. For the other band, the device may perform a separate authentication and association on the second, such as a 6 GHz band, generate a secure key specific to the 6 GHz band based on the MAC address of a radio corresponding to the 6 GHz band, and use it to communicate over the 6 GHz band.

At block 604, the apparatus may communicate, through each radio of the radios on a corresponding frequency band and using a corresponding generated secure key. For example, a first secure key generated based on a MAC address corresponding to a first radio associated with a first frequency band may be used to communicate over the first frequency band while a second secure key generated based on a MAC address corresponding to a second radio associated with a second frequency band may be used to communicate over the second frequency band. In various configurations, the frames transmitted on each band may use the MAC address of the radio that corresponds to/associated with that band.

Having discussed various aspects related to authentication and association, aspects related to operation of the device that has completed the authentication and association will now be discussed. In an aspect, the operation of the apparatus may be configured in a variety of ways. For example, in one configuration the apparatus that supports multi-band operation (such as on 5 GHz, 6 GHz, 2.4 GHz, 900 MHz etc.) may operate independently on each band. The independent operation may allow the apparatus to communicate independently, such as in parallel, via the available frequency band using corresponding radios.

In another configuration, the apparatus may be configured to operate on one band (such as 5 GHz) while conditionally transferring to or enabling operations on the other band (such as a 6 GHz). Such conditional transfer may be due to, such as a link failure on a band, increased loading, deteriorating channel conditions on an active link, enablement of multi-link operation, load balancing etc.

In another configuration, the apparatus may be configured to associate on a sub-6 GHz band, such as on a 5 GHz or 2.4 GHz band, and once association is complete the apparatus may handoff to the 6 GHz band and continue operations on the 6 GHz band. For example, one or more client devices may associate with an AP on a sub-6 GHz band. Following the association, the AP may transition some or all client devices that support 6 GHz band to operate on 6 GHz band.

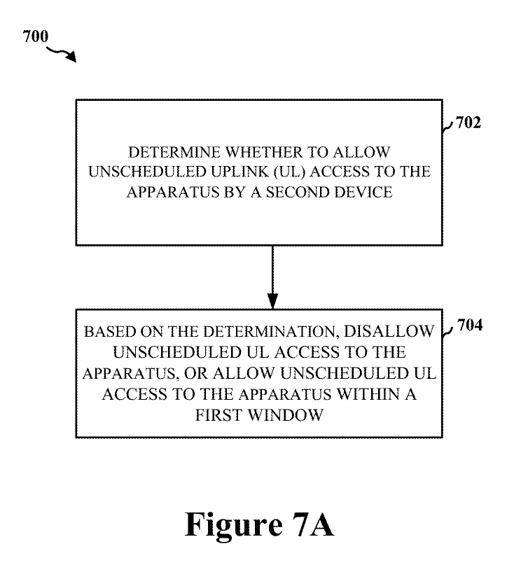

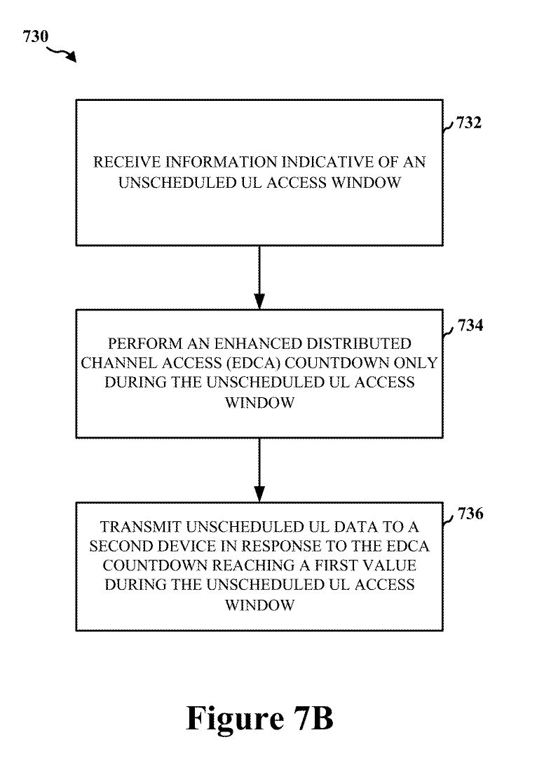

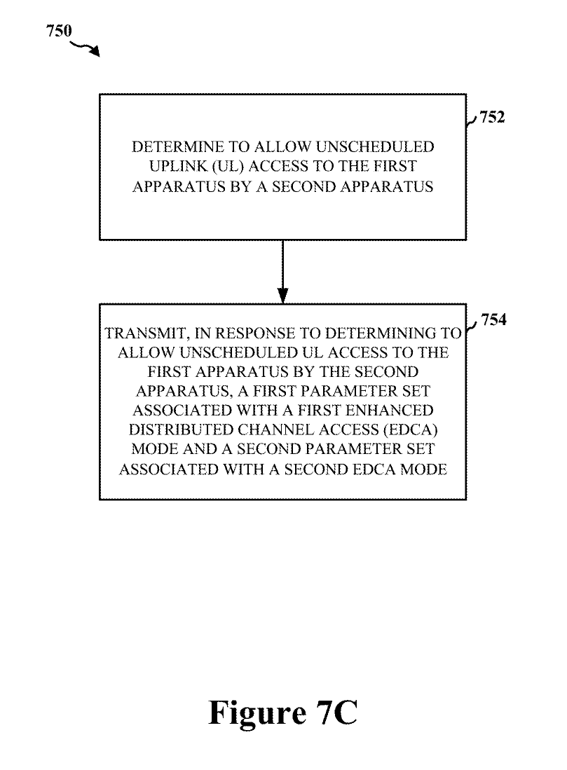

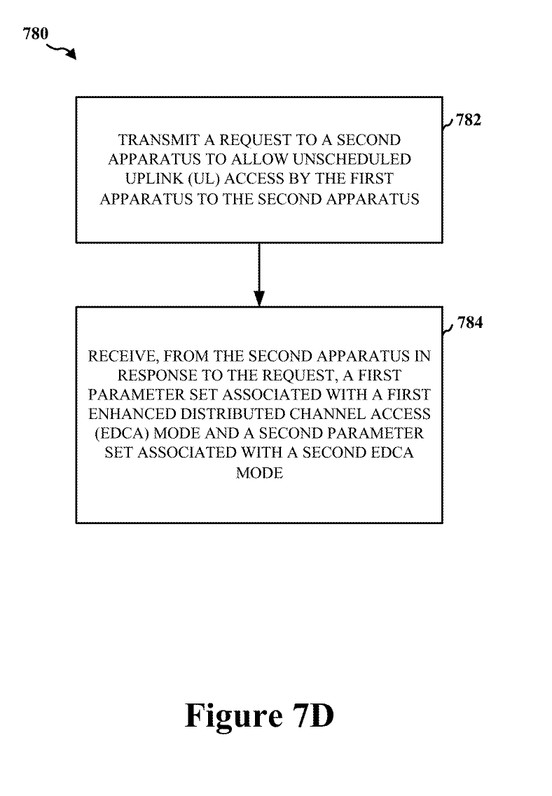

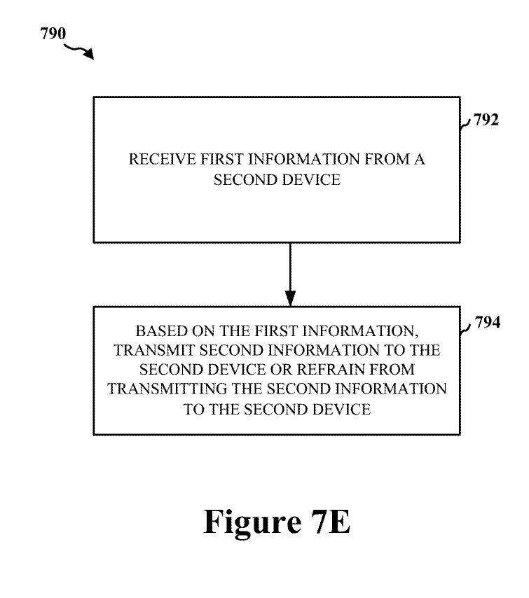

FIG. 7A is a flowchart showing an example method 700 of managing unscheduled uplink access in accordance with one or more techniques described herein. The method 700 may be performed using an apparatus (such as the AP 104, AP 202, the wireless device 802, STA 114, STA 204, any first device described herein, one of the one or more second devices described herein, or any other device configured to perform one or more techniques described herein).

At block 702, the apparatus may be configured to determine whether to allow unscheduled uplink (UL) access to the apparatus by a second device. In some examples, the unscheduled access includes allowance of at least one UL transmission from the second device to the apparatus that is not solicited by the apparatus. The at least one UL transmission may include, for example, a UL packet or a UL frame. In some examples, the at least one UL transmission from the second device that is not solicited by the apparatus may not be responsive to a trigger frame. In some examples, the at least one UL transmission from the second device that is not solicited by the apparatus follows an enhanced distributed channel access (EDCA) countdown performed by the second device. In some examples, the at least one UL transmission is initiated by the second device or not initiated by the apparatus.

At block 704, the apparatus may, based on the determination, be configured to: disallow unscheduled UL access to the apparatus, or allow unscheduled UL access to the apparatus within a first window (which may, in some examples, be referred to as an unscheduled access period, which may be a period of time between two scheduled access periods). For example, the apparatus may be configured to allow and/or disallow unscheduled UL access (that is, be configured to perform at least one of allowing or disallowing unscheduled UL access).

As an example of disallowing unscheduled UL access to the apparatus or allowing unscheduled UL access to the apparatus, the apparatus may be configured to transmit, based on the determination, first information to the second device. In some examples, the first information may include a first indication indicative of whether the second device is allowed to transmit to the apparatus outside of a scheduled access period. Additionally or alternatively, the first information may include a second indication indicative of whether the second device is allowed to transmit to the apparatus without first receiving a trigger. In some examples, the scheduled access period may include a TWT window.

In some examples, the first indication indicative of whether the second device is allowed to transmit to the apparatus outside of the scheduled access period may be indicative that the second device is allowed to transmit to the apparatus outside of the scheduled access period. In such examples, the apparatus may be configured to receive second information from the second device outside of the scheduled access period.

In some examples, the first indication indicative of whether the second device is allowed to transmit to the apparatus outside of the scheduled access period may be indicative that the second device is not allowed to transmit to the apparatus outside of the scheduled access period. In such examples, the apparatus may only receive transmissions from the second device during the scheduled access period.

In some examples, the second indication indicative of whether the second device is allowed to transmit to the apparatus without first receiving the trigger may be indicative of whether the second device is allowed to transmit to the apparatus during the scheduled access period without first receiving the trigger. In such examples, the apparatus may be configured to receive, without transmission of a trigger to the second device, second information from the second device during the scheduled access period. The second information may be any information transmitted by the second device.

In some examples, the second indication indicative of whether the second device is allowed to transmit to the apparatus without first receiving the trigger may be indicative that the second device is not allowed to transmit to the apparatus during the scheduled access period without first receiving the trigger. In such examples, the apparatus may be configured to transmit a trigger to the second device to solicit information from the second device, such as second information. Without receiving the trigger, the second device is not allowed to transmit to the apparatus during the scheduled access period. After transmitting the trigger, the apparatus may be configured to receive second information from the second device during the scheduled access period. The second information may be any information transmitted by the second device.

In some examples, to determine whether to allow unscheduled access to the apparatus by the second device, the apparatus may be configured to determine whether to allow unscheduled access to the apparatus by the second device in a first band. In some examples, the first band may be the same as an operating band of a BSS to which the apparatus belongs. In other examples, the first band may be a different operating band than the BSS to which the apparatus belongs.

In some examples, the apparatus may be configured to transmit a channel availability query (CAQ) to the second device. The apparatus may be configured to receive a CAQ response from the second device. The apparatus may be configured to perform the determination of whether to allow unscheduled UL access to the apparatus by the second device based on the CAQ response. In some examples, the CAQ response may include information corresponding to a channel. The information corresponding to the channel may include information indicative of a type of access allowed for the channel. The type of access allowed for the channel may include scheduled-only access, unscheduled access, or scheduled and unscheduled access. In some examples, scheduled access may include allowance of at least one UL transmission from the second device that is solicited by the apparatus. In some examples, scheduled access includes allowance of at least one UL transmission from the second device that is solicited by the apparatus using at least one trigger frame; and, in such examples, the at least one UL transmission that is solicited by the apparatus is responsive to the at least one trigger frame.

In some examples, the CAQ response may include a type of access field. The type of access field may include the information indicative of the type of access allowed. The apparatus may be configured to disallow unscheduled UL access to the apparatus over the channel corresponding to the CAQ response when the information indicative of the type of access in the CAQ response is scheduled-only access. In other examples, the apparatus may be configured to disallow unscheduled UL access to the apparatus over the channel corresponding to the CAQ response when the information indicative of the type of access in the CAQ response does not include unscheduled access. In other examples, the apparatus may be configured to allow unscheduled UL access to the apparatus within the first window over the channel corresponding to the CAQ response when the information indicative of the type of access in the CAQ response includes unscheduled access.

In some examples, the apparatus may be configured to determine whether a neighboring device to the apparatus is allowing or disallowing unscheduled UL access. The apparatus may be configured to determine whether to allow unscheduled UL access to the apparatus by the second device based on the determination of whether the neighboring device is allowing or disallowing unscheduled UL access. In some examples, the neighboring device may be at least one of: an overlapping basic service set (OBSS) device, an access point (AP), or the second device. For example, the neighboring device could be all three: an OBSS AP device that constitutes the second device.

The apparatus may be configured to receive a beacon frame from the neighboring device. The beacon frame may include information indicative of whether unscheduled UL access is allowed or disallowed by the neighboring device. In some examples, information indicative of whether unscheduled UL access is allowed may include identification of a second window during which unscheduled UL access is allowed by the neighboring device. The identification of the second window may include at least one of: a start time corresponding to the second window, a duration of the second window, or an end time corresponding to the second window.

In some examples, the first window is the same as the second window. In other examples, the first window may be different than the second window. However, receiving information regarding the second window by the apparatus may inform the apparatus whether unscheduled UL access is allowed or disallowed by the neighboring device. In some examples, the apparatus may be configured to set the duration of the first window to be the same as the duration of the second window. In other examples, the apparatus may be configured to set the duration of the first window to be different than the duration of the second window.

In some examples, the apparatus may be configured to disallow unscheduled UL access to the apparatus when the neighboring device is disallowing unscheduled UL access (such as when the neighboring device is configured to disallow unscheduled UL access). In other examples, the apparatus may be configured to disallow unscheduled UL access to the apparatus when the beacon frame includes information indicative of that unscheduled access is disallowed by the neighboring device.

In some examples, the apparatus may be configured to allow unscheduled UL access to the apparatus within the first window when the neighboring device is allowing unscheduled UL access (such as when the neighboring device is configured to allow unscheduled UL access). In other examples, the apparatus may be configured to allow unscheduled UL access to the apparatus within the first window when the beacon frame includes information indicative of that unscheduled access is allowed by the neighboring device. In some examples, the beacon frame is an overlapping basic service set (OBSS) beacon frame, which may indicate that the beacon frame originated from an OBSS AP (that is, the neighboring device may be an OBSS AP).

Referring to the first window, the first window may be, in some examples, a target wake time (TWT). The TWT may be included in a field of a TWT element. The TWT element may include an access type field. The access type field may include information indicative of a type of access allowed by the apparatus. In some examples, the type of access allowed by the apparatus may include scheduled-only access, unscheduled access, or scheduled and unscheduled access.

In some examples, the apparatus may be configured to allow unscheduled UL access to the apparatus within the first window by being configured to transmit information indicative of the first window to the second device to instruct the second device that unscheduled UL access is allowed during the first window. The information indicative of the first window may include at least one of: a start time corresponding to the first window, a duration of the first window, or an end time corresponding to the first window. In some examples, the information indicative of the first window may be transmitted by the apparatus to the second device in a target wake time (TWT) element. As described above, the TWT element may include a TWT field that includes the information indicative of the first window

In some examples, the apparatus may be configured to transmit information indicative of an enhanced distributed channel access (EDCA) countdown that is to be performed during the first window. In some examples, the second device may be configured to perform an EDCA countdown during the second window. The second device may be configured to transmit unscheduled UL data to the apparatus in response to the EDCA countdown reaching a value. In some examples, the value may be zero, meaning that the second device may be configured to transmit unscheduled UL data to the apparatus in response to the EDCA countdown reaching zero. In some examples, the value may be referred to as a threshold value.

In some examples, the apparatus may be configured to allow and/or disallow unscheduled UL access. For example, the apparatus may be configured to allow unscheduled UL access to the apparatus within the first window, or disallow unscheduled UL access to the apparatus within a second window. In such an example, the first window and the second window may be different, or the first window and the second window may overlap. In the example of overlapping windows, the apparatus may be configured to prioritize disallowing unscheduled UL access over allowing unscheduled UL access during the period of overlap between the first window and the second window.

In some examples, the unscheduled uplink access described herein may refer to single-user (SU) unscheduled uplink access.

FIG. 7B is a flowchart showing an example method 730 of managing unscheduled uplink access in accordance with one or more techniques described herein. The method 730 may be performed using an apparatus (such as the AP 104, AP 202, the wireless device 802, STA 114, STA 204, any first device described herein, one of the one or more second devices described herein, or any other device configured to perform one or more techniques described herein).

At block 732, the apparatus may be configured to receive information indicative of an unscheduled UL access window. In some examples, the information indicative of the unscheduled UL access window may include at least one of: a start time corresponding to the unscheduled UL access window, a duration of the unscheduled UL access window, or an end time corresponding to the unscheduled UL access window. Unscheduled access generally refers to access that occurs outside of a scheduled access period. In some examples, an unscheduled access period (such as an unscheduled UL access window) may refer to any time outside of a scheduled access period. In some examples, an unscheduled access period may be a period of time that is outside of a scheduled access period. The period of time in such examples may be a window that has a specified length of time, the window being outside of the scheduled access period. For example, the unscheduled access period may be between two scheduled access periods; and, as such, the time between the two scheduled access periods may be referred to as an unscheduled access period. In the example of FIG. 7B, an unscheduled UL access window may refer to any time outside of a scheduled access window. As another example, an unscheduled UL access window may be a period of time that is outside of a scheduled access window. The period of time in such an example may be a window that has a specified length of time, the window being outside of the scheduled access period. For example, the unscheduled access period may be between two scheduled access periods; and, as such, the time between the two scheduled access periods may be referred to as an unscheduled access period.

At block 734, the apparatus may be configured to perform an enhanced distributed channel access (EDCA) countdown only during the unscheduled UL access window. At block 736, the apparatus may be configured to transmit unscheduled UL data to a second device in response to the EDCA countdown reaching a first value during the unscheduled UL access window. In some examples, the EDCA countdown may include an EDCA countdown value that is decremented during the EDCA countdown. The apparatus may be configured to perform the EDCA countdown only during the unscheduled UL access window, meaning that the EDCA countdown value may only be decremented and reach the first value during the unscheduled UL access window. In some examples, the first value may be referred to as a threshold value.

In some examples, the information indicative of an unscheduled UL access window may be received from the second device. In such examples, the information indicative of an unscheduled UL access window may be received from the second device in a target wake time (TWT) element. The TWT element may include an access type field. The access type field may include information indicative of a type of access allowed by the second device. The type of access allowed by the second device may include scheduled-only access, unscheduled access, or scheduled and unscheduled access. The type of access may indicate that (1) unscheduled uplink access is allowed or (2) unscheduled uplink access is disallowed. In some examples, the type of access field in the TWT element may have a length. The length may be one or more bits, depending the example. For example, a 1-bit type of access field may include a first value indicative that unscheduled access is allowed or a second value indicative that unscheduled access is not allowed.

In other examples, the information indicative of an unscheduled UL access window may be received from the second device in a beacon frame. The beacon frame may include an information element (IE) that includes the information indicative of the unscheduled UL access window.

FIG. 7C is a flowchart showing an example method 750 of managing unscheduled uplink access in accordance with one or more techniques described herein. The method 750 may be performed using a first apparatus, which may be any apparatus described herein (such as the AP 104, AP 202, the wireless device 802, STA 114, STA 204, or any other device configured to perform one or more techniques described herein). The second apparatus may be any apparatus described herein (such as the AP 104, AP 202, the wireless device 802, STA 114, STA 204, or any other device configured to perform one or more techniques described herein).

At block 752, the first apparatus may be configured to determine to allow unscheduled uplink (UL) access to the first apparatus by a second apparatus. The unscheduled UL access may include allowance of at least one UL transmission from the second apparatus to the first apparatus that is not solicited by the first apparatus. At block 754, the first apparatus may be configured to transmit, in response to determining to allow unscheduled UL access to the first apparatus by the second apparatus, a first parameter set associated with a first enhanced distributed channel access (EDCA) mode and a second parameter set associated with a second EDCA mode. The first parameter set may include information indicative of start time of a first unscheduled UL access window at which the second apparatus is to use the first parameter set and the second parameter set comprises information indicative of a start time of a second unscheduled UL access window at which the second apparatus is to use the second parameter set.

In some examples, a parameter set described herein may include one or more parameters that determine the timing of an unscheduled UL access from a second apparatus. For example, the parameter set may specify one or more no-contention-windows during which the second apparatus is prevented from contending for the medium such as channel resources shared by a plurality of apparatus for transmitting UL data. The parameter set may also specify one or more contention-windows during which the second apparatus is allowed to contend for the medium. The second apparatus may countdown an EDCA timer within a contention-window. When the EDCA countdown reaches a value, such as zero or another threshold value, the second apparatus may be configured to transmit unscheduled UL data to the apparatus. The EDCA countdown may be a randomized number to allow for a more uniform distribution of the probability of collision between the second apparatus and another apparatus contending for the medium for unscheduled UL accesses during a contention-window. A parameter set that specifies a shorter no-contention-window and/or a longer contention-window enables the second apparatus receiving it to have a higher probability of successfully contending for the medium. The unscheduled UL access may have a higher probability of being granted access to the shared channel resources and thus may have a higher priority. On the other hand, a parameter set that specifies a longer no-contention-window and/or a shorter contention-window gives the second apparatus receiving it a lower probability of successfully contending for the medium. The unscheduled UL access may have a lower probability of being granted access to the shared channel resources and thus may have a lower priority. Thus, the first apparatus may transmit a first parameter set that is different from a second parameter set to vary the priority of unscheduled UL accesses for the first EDCA mode and for the second EDCA mode. The first and second EDCA mode may be one of a single-user (SU) EDCA mode or a multi-user (MU) EDCA mode. The SU EDCA mode may also be referred to as a SU unscheduled uplink access mode. The MU EDCA mode may also be referred to as a triggered-based (TB) EDCA mode, a MU unscheduled uplink access mode, or a TB unscheduled uplink access mode.

In some examples, the first parameter set or the second parameter set may include one or more parameters for one of a plurality of access categories. The parameters for each access category may enable UL data corresponding to the different access categories to have various levels of priority for unscheduled UL access. For example, the access categories may include voice, video, background data, and best effort data. The first parameter set or the second parameter set may enable the voice, video, background data, and best effort data to have descending order of priority for unscheduled UL access.

In some examples, the first or the second parameter set may include an arbitration inter-frame space number (AIFSN) parameter, a contention window minimum (CW MIN) parameter, a contention window maximum (CW MAX) parameter, a Transmit Opportunity Limit (TXOP) parameter. The AIFSN parameter may be used to specify the no-contention-window. The CW MIN and CW MAX parameters may be used to specify the contention-window. In some examples, when the AIFSN is set to 0, the second apparatus is prevented from performing unscheduled UL access to the first apparatus in the EDCA mode associated with the parameter set.

In some examples, the first parameter set may include information to indicate to the second apparatus when to start using the first parameter set associated with the first EDCA mode. Similarly, the second parameter set may include information to indicate to the second apparatus when to start using the second parameter set associated with the second EDCA mode. In some examples, the parameter set may include information to indicate to the second apparatus to start using the parameter set and to be in the associated EDCA mode as soon as the second apparatus receives the parameter set. For example, if the first apparatus transmits a parameter set associated with the MU EDCA mode to the second apparatus while the second apparatus is in the SU EDCA mode using the parameter set associated with the SU EDCA mode, the second apparatus may terminate the SU EDCA mode and switch to the MU EDCA mode to start using the parameter set associated with the MU EDCA mode. In some examples, the first apparatus may be configured to indicate to the second indicate to start using the first parameter set during a first service period and to start using the second parameter set during a second service period.

In some examples, the first parameter set may include information to indicate to the second apparatus a first unscheduled UL access window during which the second apparatus is to use the first parameter set associated with the first EDCA mode and the second parameter set may include information to indicate to the second apparatus a second unscheduled UL access window during which the second apparatus is to use the second parameter set associated with the second EDCA mode. The unscheduled UL access window may include one or more no-contention-windows and one or more contention-windows described above. In some examples, the unscheduled UL access window for a current EDCA mode may last until the first apparatus transmits a new parameter set to the second apparatus to switch the second apparatus to use the new parameter set. For example, the second apparatus may maintain the unscheduled UL access window in the SU EDCA mode until the first apparatus transmits a parameter set associated with the MU EDCA mode to the second apparatus. The second apparatus may then terminate the unscheduled UL access window in the SU EDCA mode and stop using the parameter set associated with the SU EDCA mode. The second apparatus may start the unscheduled UL access window in the MU EDCA mode and start using the parameter set associated with the MU EDCA mode. In some examples, the first apparatus may transmit a switch signal to switch the second apparatus from using a parameter set associated with an EDCA mode to another parameter set associated with another EDCA mode. The switch signal may be or include information that enables or allows the second apparatus to switch from using one EDCA parameter set to another EDCA parameter set.

In some examples, the information that indicates to the second apparatus the unscheduled UL access window may be a use timer (which may also be referred to as an expiration timer). The use timer may be part of the parameter set and may specify the duration of the UL access window during which the second apparatus is to use the parameter set associated with the EDCA mode. The second apparatus may countdown the use timer within the UL access window. In some examples, when the use timer counts down to zero or to another threshold value, the unscheduled UL access window may stop using the associated parameter set. In some examples, even when the use timer counts down to zero or to another threshold value, the unscheduled UL access may continue to use the associated parameter set. For example, the parameter set associated with the MU EDCA mode may include a MU EDCA timer. When the second apparatus starts the unscheduled UL access window in the MU EDCA mode to start using the parameter set associated with the MU EDCA mode, the second apparatus may countdown the MU EDCA timer. Even when the MU EDCA timer counts down to zero, the second apparatus may continue to use the parameter set associated with the MU EDCA mode for the unscheduled UL access until the first apparatus transmits a new parameter set to the second apparatus. In some examples, when the MU EDCA timer counts down to zero, the second apparatus may stop using the parameter set associated with the MU EDCA mode, but may remain in the MU EDCA mode until the first apparatus transmits a new parameter set to the second apparatus or until the first apparatus transmits a switch signal to switch the second apparatus to the SU EDCA mode. In some examples, after the second apparatus stops using the parameter set, the first apparatus may transmit a trigger event within the unscheduled UL access window to tell the second apparatus to start using the parameter set again. In some examples, the second apparatus may be maintained in the MU EDCA mode, and the first apparatus may transmit one or more trigger events (such as one or more trigger frames) to the second apparatus to start a new unscheduled UL access window for each trigger event. In some examples, the MU EDCA timer may be infinite or the use timer parameter may be set to a value that indicates the use timer does not expire.

In some examples, the countdown of the use timer may be initiated by a trigger event. In some examples, the first apparatus may transmit a trigger frame as a trigger event to the second apparatus to tell the second apparatus to start using the parameter set associated with an EDCA mode and to initiate the countdown of the user time. In some examples, when the second apparatus receives the trigger frame, the second apparatus may transmit an UL data corresponding to an access configuration associated with the parameter set. The UL data may be used as a trigger event to initiate the countdown of the use timer. In one or more examples, the first or the second parameter set may enable the second apparatus to perform one or more EDCA timer countdowns for the UL unscheduled access. The one or more EDCA timer countdowns may be suspended.

In some examples, the first apparatus may be configured to switch the second apparatus from one EDCA mode to another EDCA mode. In some examples, the switch signal may occur only during certain time, such as a service period scheduled by the apparatus. For example, when the second apparatus is in the MU EDCA mode, the second apparatus may remain in the MU EDCA mode until the first apparatus transmits an announced target wake time (TWT) service period. The service period may have a start time and an end time.

In other examples, the example method 730 of unscheduled UL access performed by the apparatus may be configured by the second apparatus as described above for example method 700. The example method 730 allows the apparatus to receive a first parameter set associated with a first EDCA mode and a second parameter set associated with a second EDCA mode. The first parameter set or second parameter set may include one or more parameters that determine the timing of the unscheduled UL access from the apparatus. The apparatus in method 730 may include a station (such as station 114/204) and the second apparatus in method 730 may include an AP (such as the AP 104/204).

FIG. 7D is a flowchart showing an example method 780 of managing unscheduled uplink access in accordance with one or more techniques described herein. The method 780 may be performed using a first apparatus, which may be any apparatus described herein (such as the AP 104, AP 202, the wireless device 802, STA 114, STA 204, or any other device configured to perform one or more techniques described herein). The second apparatus may be any apparatus described herein (such as the AP 104, AP 202, the wireless device 802, STA 114, STA 204, or any other device configured to perform one or more techniques described herein).

At block 782, the first apparatus may be configured to transmit a request to a second apparatus to allow unscheduled uplink (UL) access by the first apparatus to the second apparatus. The unscheduled UL access may include allowance of at least one UL transmission from the first apparatus to the second apparatus that is not solicited by the second apparatus. At block, 784, the first apparatus may be configured to receive, from the second apparatus in response to the request, a first parameter set associated with a first enhanced distributed channel access (EDCA) mode and a second parameter set associated with a second EDCA mode. In other examples, the first apparatus may be configured to receive the first parameter set and the second parameter set without sending a request to the second apparatus. In such examples, the second apparatus may be configured to transmit the first parameter set and the second parameter set to the first apparatus without being requested to do so by the first apparatus. The first parameter set may include information indicative of a start time of a first unscheduled UL access window at which the first apparatus is to use the first parameter set and the second parameter set may include information indicative of a start time of a second unscheduled UL access window at which the first apparatus is to use the second parameter set.

FIG. 7E is a flowchart showing an example method 790 of managing unscheduled uplink access in accordance with one or more techniques described herein. The method 790 may be performed using an apparatus (such as the AP 104, AP 202, the wireless device 802, STA 114, STA 204, any first device described herein, one of the one or more second devices described herein, or any other device configured to perform one or more techniques described herein).

At block 792, the apparatus may be configured to receive first information from a second device. The first information may include a first indication indicative of whether the apparatus is allowed to transmit to the second device outside of a scheduled access period, or a second indication indicative of whether the apparatus is allowed to transmit to the second device without first receiving a trigger from the second device. At block 794, based on the first information, the apparatus may be configured to transmit second information to the second device, or refrain from transmitting the second information to the second device. The second information may be any information. In some examples, the scheduled access period may include a TWT window.

In some examples, the first indication indicative of whether the apparatus is allowed to transmit to the second device outside of the scheduled access period may be indicative that the apparatus is allowed to transmit to the second device outside of the scheduled access period. In such examples, the apparatus may be configured to transmit second information to the second device outside of the scheduled access period. Otherwise described, if the apparatus receives such a first indication, the apparatus may then transmit second information to the second device outside of the scheduled access period because of having received the first indication.

In some examples, the first indication indicative of whether the apparatus is allowed to transmit to the second device outside of the scheduled access period may be indicative that the apparatus is not allowed to transmit to the second device outside of the scheduled access period. In such examples, the apparatus may be configured to refrain from transmitting second information to the second device outside of the scheduled access period because of having received the first indication.

In some examples, the second indication indicative of whether the apparatus is allowed to transmit to the second device without first receiving the trigger may be indicative of whether the apparatus is allowed to transmit to the second device during the scheduled access period without first receiving the trigger. In such examples, based the second indication, the apparatus may be configured to transmit, without first receiving a trigger (such as a trigger frame) from the second device, second information to the second device during the scheduled access period.

In some examples, the second indication indicative of whether the apparatus is allowed to transmit to the second device without first receiving the trigger may be indicative that the apparatus is not allowed to transmit to the second device during the scheduled access period without first receiving the trigger. In such examples, the apparatus may be configured to refrain from transmitting second information to the second device during the scheduled access period unless the apparatus receives a trigger (such as a trigger frame) from the second device. For example, the apparatus may be configured to receive a trigger from the second device. The apparatus may then transmit second information to the second device during the scheduled access period in response to the receiving the trigger.

In some examples, the first indication indicative of whether the apparatus is allowed to transmit to the second device outside of the scheduled access period may be indicative of whether the apparatus is allowed to transmit to the second device outside of the scheduled access period in a first band. In some examples, the first band may be the same as an operating band of a BSS to which the second device belongs. In other examples, the first band may be a different operating band than the BSS to which the second device belongs.

In some examples, the second indication indicative of whether the apparatus is allowed to transmit to the second device without first receiving the trigger from the second device may be indicative of whether the apparatus is allowed to transmit to the second device in a first band without first receiving a trigger from the second device. In some examples, the first band may be the same as an operating band of a BSS to which the second device belongs. In other examples, the first band may be a different operating band than the BSS to which the second device belongs.

FIG. 8 shows a functional block diagram of an example wireless communication apparatus. For example, FIG. 8 shows a functional block diagram of an example wireless device 802 within the wireless communication system 100 of FIG. 1. The wireless device 802 is an example of a device that may be configured to implement the various methods described herein. For example, the wireless device 802 may comprise an AP (such as the AP 104/204) or a station (such as station 114/204).

The wireless device 802 may include a processor 804 which controls operation of the wireless device 802. The processor 804 may also be referred to as a central processing unit (CPU). Memory 806, which may include both read-only memory (ROM) and random access memory (RAM), may provide instructions and data to the processor 804. A portion of the memory 806 may also include non-volatile random access memory (NVRAM). The processor 804 typically performs logical and arithmetic operations based on program instructions stored within the memory 806. The instructions in the memory 806 may be executable (by the processor 804, for example) to implement the methods described herein.

The processor 804 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (such as in source code format, binary code format, executable code format, or any other suitable format of code). The instructions, when executed by the one or more processors, cause the processing system to perform the various functions described herein.

The wireless device 802 may also include a housing 808, and the wireless device 802 may include a transmitter 810 and/or a receiver 812 to allow transmission and reception of data between the wireless device 802 and a remote device. The transmitter 810 and the receiver 812 may be combined into a transceiver 814. An antenna 816 may be attached to the housing 808 and electrically coupled to the transceiver 814. The wireless device 802 may also include multiple transmitters, multiple receivers, multiple transceivers, and/or multiple antennas.

The wireless device 802 may also include a signal detector 818 that may be used to detect and quantify the level of signals received by the transceiver 814 or the receiver 812. The signal detector 818 may detect such signals as total energy, energy per subcarrier per symbol, power spectral density, and other signals. The wireless device 802 may also include a DSP 820 for use in processing signals. The DSP 820 may be configured to generate a packet for transmission. In some aspects, the packet may comprise a physical layer convergence procedure (PLCP) PHY protocol data unit (PPDU). PHY refers to physical layer.

The wireless device 802 may further comprise a user interface 822 in some aspects. The user interface 822 may comprise a keypad, a microphone, a speaker, and/or a display. The user interface 822 may include any element or component that conveys information to a user of the wireless device 802 and/or receives input from the user.

When the wireless device 802 is implemented as an AP (such as the AP 104) or as a STA (such as the STA 114), the wireless device 802 may also comprise a resource allocation component 824. When the wireless device 802 is implemented as a station (such as station 114), may include a communication control component to perform procedures related to authentication and association with the AP 104, establishing secure key(s) in accordance with the methods described herein and communicate over the available frequency bands, such as 2.4 GHz, 5 GHz, 6 GHz and/or other available bands.

The various components of the wireless device 802 may be coupled together by a bus system 826. The bus system 826 may include a data bus, for example, as well as a power bus, a control signal bus, and a status signal bus in addition to the data bus. Components of the wireless device 802 may be coupled together or accept or provide inputs to each other using some other mechanism.

Although a number of separate components are illustrated in FIG. 8, one or more of the components may be combined or commonly implemented. For example, the processor 804 may be used to implement not only the functionality described above with respect to the processor 804, but also to implement the functionality described above with respect to the signal detector 818, the DSP 820, the user interface 822, and/or the resource allocation component 824. Further, each of the components shown and described with reference to FIG. 8 may be implemented using a plurality of separate elements.

In an aspect, devices that support operations in 6 GHz may signal (such as to other devices) this capability information either via a capabilities element (such as HE Capabilities) or via operation element (such as HE Operation element) or via a new element or a field. In some configurations, the support could be indicated via a combination of one or more bits or a fields which may also include parameters for operating in the 6 GHz band. In addition, devices may indicate support to operate on multiple bands simultaneously. This may be done via a new field or an element or extending existing elements/fields (such as the Multi-band element (as defined in 9.4.2.138 of IEEE 802.11-2016 spec)). Further, in some configurations when operating in multi-band configuration, the two devices may setup a common Block ACK (BA) session or maintain a separate BA session (per link). The signaling for BA setup may use existing mechanism such as exchanging ADDBA Request/Response frames which may include Multi-Band element. With a common BA session, multiple links may have a common scoreboard and share the sequence number space.

Various examples in accordance with the techniques of this disclosure are described herein. Such examples include the examples described above as well as the examples described below.

### Example 1

A method for wireless communication, comprising: determining a virtual medium access control (MAC) address based on a subset of MAC addresses of a set of MAC addresses associated with radios of the apparatus, each MAC address of the set of MAC addresses being associated with a different radio of the radios; generating a secure key through an association procedure that is based on the determined virtual MAC address; and communicating, using the generated secure key, through a plurality of the radios on a plurality of different frequency bands, the plurality of the radios being associated with the subset of MAC addresses.

### Example 2

The method of example 1, wherein the virtual MAC address is generated based on 48-n common bits of the subset of MAC addresses, where n is the number of uncommon bits of the subset of MAC addresses.

### Example 3

The method of example 1, wherein the virtual MAC address is generated based on one or more MAC addresses of the subset of MAC addresses.

### Example 4

The method of example 1, wherein the virtual MAC address is based on a hash of the subset of MAC addresses.

### Example 5

The method of example 1, wherein the different frequency bands include a 6 GHz frequency band, and at least one other frequency band including a 5 GHz frequency band, a 2.4 GHz frequency band, or a 900 MHz frequency band.

### Example 6

The method of example 1, wherein the subset of MAC addresses includes all MAC addresses in the set of MAC addresses.

### Example 7

The method of example 1, wherein the communicating comprises at least one of transmitting or receiving a frame using the generated secure key on each of the plurality of different frequency bands.

### Example 8

A method for wireless communication, comprising: generating a secure key through an association procedure that is based on a plurality of medium access control (MAC) addresses associated with radios of an apparatus; and communicating, using the generated secure key, through the radios on a plurality of different frequency bands.

### Example 9

The method of example 8, wherein the different frequency bands include a 6 GHz frequency band, and at least one frequency band including a 5 GHz frequency band, a 2.4 GHz frequency band, or a 900 MHz frequency band.

### Example 10

The method of example 8, wherein the communicating comprises at least one of transmitting or receiving a frame using the generated secure key on each of the plurality of different frequency bands.

### Example 11

A method for wireless communication, comprising: generating a secure key through an association procedure that is based on a medium access control (MAC) address associated with a first radio of a plurality of radios of an apparatus, the first radio being associated with a first frequency band of a plurality of frequency bands; and communicating, using the generated secure key, through a second radio of the plurality of radios on a second frequency band of the plurality of frequency bands.

### Example 12

The method of example 11, wherein the secure key is unassociated with a MAC address of the second radio.

### Example 13

The method of example 11, wherein the communication through the second radio is performed without performing an association procedure in association with the second frequency band.

### Example 14

The method of example 11, wherein the second frequency band is a 6 GHz frequency band, and the first frequency band is one of a 5 GHz frequency band, a 2.4 GHz frequency band, or a 900 MHz frequency band.

### Example 15

A method for wireless communication, comprising: generating a plurality of secure keys through association procedures that are based on a plurality of medium access control (MAC) addresses associated with radios of an apparatus, each radio of the radios being associated with a different frequency band of a plurality of frequency bands; and communicating through each radio of the radios on a corresponding frequency band and using a corresponding generated secure key.

### Example 16

The method of example 15, wherein the plurality of frequency bands include a 6 GHz frequency band, and at least one frequency band including a 5 GHz frequency band, a 2.4 GHz frequency band, or a 900 MHz frequency band.

### Example 17

A method for wireless communication, comprising: determining, by a first device, whether to allow unscheduled uplink (UL) access to the first device by a second device, wherein unscheduled access includes allowance of at least one UL transmission from the second device to the first device that is not solicited by the first device; and performing, by the first device based on the determination, at least one of: disallowing unscheduled UL access to the first device; or allowing unscheduled UL access to the first device within a first window.

### Example 18

The method of example 17, wherein the at least one UL transmission from the second device that is not solicited by the first device is not responsive to a trigger frame.

### Example 19

The method of example 17, wherein the at least one UL transmission from the second device that is not solicited by the first device follows an enhanced distributed channel access (EDCA) countdown performed by the second device.

### Example 20

The method of example 17, wherein the at least one UL transmission is initiated by the second device.

### Example 21

The method of example 17, further comprising: transmitting, by the first device, a channel availability query (CAQ) to the second device; and receiving, by the first device, a CAQ response from the second device, wherein the determination of whether to allow unscheduled UL access to the first device by the second device is based on the CAQ response.

### Example 22

The method of example 21, wherein the CAQ response includes information corresponding to a channel, and wherein the information corresponding to the channel includes information indicative of a type of access allowed for the channel.

### Example 23

The method of example 22, wherein the type of access allowed for the channel includes scheduled-only access, unscheduled access, or scheduled and unscheduled access.

### Example 24

The method of example 23, wherein scheduled access includes allowance of at least one UL transmission from the second device that is solicited by the first device.

### Example 25

The method of example 23, wherein scheduled access includes allowance of at least one UL transmission from the second device that is solicited by the first device using at least one trigger frame.

### Example 26

The method of example 25, wherein the at least one UL transmission that is solicited by the first device is responsive to the at least one trigger frame.

### Example 27

The method of example 22, wherein the CAQ response includes a type of access field that includes the information indicative of the type of access allowed.

### Example 28

The method of example 22, further comprising: disallowing unscheduled UL access to the first device over the channel corresponding to the CAQ response when the information indicative of the type of access in the CAQ response is scheduled-only access.

### Example 29

The method of example 22, further comprising: disallowing unscheduled UL access to the first device over the channel corresponding to the CAQ response when the information indicative of the type of access in the CAQ response does not include unscheduled access.

### Example 30

The method of example 22, further comprising: allowing unscheduled UL access to the first device within the first window over the channel corresponding to the CAQ response when the information indicative of the type of access in the CAQ response includes unscheduled access.

### Example 31

The method of example 17, further comprising: determining, by the first device, whether a neighboring device to the first device is allowing or disallowing unscheduled UL access, wherein the determination of whether to allow unscheduled UL access to the first device by the second device is based on the determination of whether the neighboring device is allowing or disallowing unscheduled UL access.

### Example 32

The method of example 31, wherein the neighboring device is at least one of: an overlapping basic service set (OBSS) device; an access point (AP); or the second device.

### Example 33

The method of example 31, further comprising: receiving, by the first device, a beacon frame from the neighboring device, wherein the beacon frame includes information indicative of whether unscheduled UL access is allowed or disallowed by the neighboring device.

### Example 34

The method of example 33, wherein information indicative of whether unscheduled UL access is allowed includes identification of a second window during which unscheduled UL access is allowed by the neighboring device.

### Example 35

The method of example 34, wherein the first window is the same as the second window.

### Example 36

The method of example 34, further comprising: setting, by the first device, the duration of the first window to be the same as the duration of the second window.

### Example 37

The method of example 34, wherein identification of the second window includes at least one of: a start time corresponding to the second window; a duration of the second window; or an end time corresponding to the second window.

### Example 38

The method of example 31, further comprising: disallowing unscheduled UL access to the first device when the neighboring device is disallowing unscheduled UL access.

### Example 39

The method of example 33, further comprising: disallowing unscheduled UL access to the first device when the beacon frame includes information indicative of that unscheduled access is disallowed by the neighboring device.

### Example 40

The method of example 31, further comprising: allowing unscheduled UL access to the first device within the first window when the neighboring device is allowing unscheduled UL access.

### Example 41

The method of example 33, further comprising: allowing unscheduled UL access to the first device within the first window when the beacon frame includes information indicative of that unscheduled access is allowed by the neighboring device.

### Example 42

The method of example 33, wherein the beacon frame is an overlapping basic service set (OBSS) beacon frame.

### Example 43

The method of example 17, wherein the first window is a target wake time (TWT) included in a field of a TWT element.

### Example 44

The method of example 43, wherein the TWT element includes an access type field that includes information indicative of a type of access allowed by the first device.

### Example 45

The method of example 44, wherein the type of access allowed by the first device includes scheduled-only access, unscheduled access, or scheduled and unscheduled access.

### Example 46

The method of example 17, wherein allowing unscheduled UL access to the first device within the first window includes: transmitting, by the first device, the information indicative of the first window to the second device to instruct the second device that unscheduled UL access is allowed during the first window.

### Example 47

The method of example 46, the information indicative of the first window includes at least one of: a start time corresponding to the first window; a duration of the first window; or an end time corresponding to the first window.

### Example 48

The method of example 46, the information indicative of the first window is transmitted to the second device in a target wake time (TWT) element.

### Example 49

The method of example 48, wherein the TWT element includes a TWT field that includes the information indicative of the first window.

### Example 50

The method of example 49, wherein the information indicative of the first window includes at least one of: a start time corresponding to the first window; a duration of the first window; or an end time corresponding to the first window.

### Example 51

The method of example 49, wherein the TWT element includes an access type field that includes information indicative of a type of access allowed by the first device, and wherein the type of access allowed by the first device includes scheduled-only access, unscheduled access, or scheduled and unscheduled access.

### Example 52

The method of example 46, the information indicative of the first window is transmitted to the second device in a beacon frame, wherein the beacon frame includes an information element (IE) that includes at least one of: a start time corresponding to the first window; a duration of the first window; or an end time corresponding to the first window.

### Example 53

The method of example 17, further comprising: performing, by the second device, an enhanced distributed channel access (EDCA) countdown during the first window; and transmitting, by the second device, unscheduled UL data to the first device in response to the EDCA countdown reaching a first value.

### Example 54

The method of example 48, wherein the first value is zero.

### Example 55

The method of example 17, wherein unscheduled UL access includes single user (SU) unscheduled UL access.

### Example 56

The method of example 17, further comprising at least one of: allowing, within the first window, unscheduled UL access to the first device; or disallowing, within a second window, unscheduled UL access to the first device.

### Example 57

The method of example 56, wherein at least one of: the first window and the second window are different, or the first window and the second window overlap.

### Example 58

The method of example 17, wherein the first device is an access point station (AP STA), and wherein at the second device is an AP STA or a non-AP STA.

### Example 59

The method of example 19, wherein the EDCA countdown is only performed during the first window.

### Example 60

The method of example 59, wherein the first window is a target wake time (TWT) included in a field of a TWT element.

### Example 61

The method of example 60, wherein the TWT element includes an access type field that includes information indicative of a type of access allowed by the first device.

### Example 62

The method of example 61, wherein the type of access allowed by the first device includes scheduled-only access, unscheduled access, or scheduled and unscheduled access.

### Example 63

The method of example 19, wherein an EDCA countdown value corresponding to the EDCA countdown is decremented during the EDCA countdown only during the first window.

### Example 64

The method of example 63, wherein the first window is a target wake time (TWT) included in a field of a TWT element.

### Example 65

The method of example 64, wherein the TWT element includes an access type field that includes information indicative of a type of access allowed by the first device.

### Example 66

The method of example 65, wherein the type of access allowed by the first device includes scheduled-only access, unscheduled access, or scheduled and unscheduled access.

### Example 67

The method of example 53, wherein the EDCA countdown is only performed during the first window.

### Example 68

The method of example 53, wherein an EDCA countdown value corresponding to the EDCA countdown is decremented during the EDCA countdown only during the first window until the EDCA countdown value reaches the first value.

### Example 69

A method for wireless communication, comprising: receiving, by a first device, information indicative of an unscheduled uplink (UL) access window, wherein the information indicative of the unscheduled UL access window includes at least one of: a start time corresponding to the unscheduled UL access window, a duration of the unscheduled UL access window, or an end time corresponding to the unscheduled UL access window; performing, by the first device, an enhanced distributed channel access (EDCA) countdown only during the unscheduled UL access window; and transmitting, by the first device, unscheduled UL data to a second device in response to the EDCA countdown reaching a first value during the unscheduled UL access window.

### Example 70

The method of example 69, wherein the information indicative of an unscheduled UL access window is received from the second device.

### Example 71

The method of example 69, wherein the information indicative of an unscheduled UL access window is received from the second device in a target wake time (TWT) element.

### Example 72

The method of example 71, wherein the TWT element includes an access type field that includes information indicative of a type of access allowed by the second device, and wherein the type of access allowed by the second device includes scheduled-only access, unscheduled access, or scheduled and unscheduled access.

### Example 73

The method of example 69, wherein the information indicative of an unscheduled UL access window is received from the second device in a beacon frame.

### Example 74

The method of example 73, wherein the beacon frame includes an information element (IE) that includes the information indicative of the unscheduled UL access window.

### Example 75

The method of example 69, wherein an EDCA countdown value corresponding to the EDCA countdown is decremented during the EDCA countdown only during the unscheduled UL access window until the EDCA countdown value reaches the first value.

### Example 76

A method for wireless communication, comprising: determining, by a first device, to allow unscheduled uplink (UL) access to the first device by a second device, wherein the unscheduled UL access comprises allowance of at least one UL transmission from the second device to the first device that is not solicited by the first device; and transmitting by the first device, in response to determining to allow unscheduled UL access to the first device by the second device, a first parameter set associated with a first enhanced distributed channel access (EDCA) mode and a second parameter set associated with a second EDCA mode, wherein the first parameter set comprises information indicative of a start time of a first unscheduled UL access window at which the second device is to use the first parameter set and the second parameter set comprises information indicative of a start time of a second unscheduled UL access window at which the second device is to use the second parameter set.

### Example 77

The method of example 76, wherein the first unscheduled UL access window is a period of time during which the second device uses one or more parameters from the first parameter set in the first EDCA mode, and wherein the second unscheduled UL access window is a period of time during which the second device uses one or more parameters from the second parameter set in the second EDCA mode.

### Example 78

The method of example 76, wherein the second parameter set comprises information indicative of a use timer, wherein the use timer specifies a time duration for the second device to use the second parameter associated with the second EDCA mode.

### Example 79

The method of example 76, wherein the second parameter set takes effect at the start time corresponding to the second unscheduled UL access window, and is valid for a duration of the second unscheduled UL access window, and wherein the first parameter set takes effect at the start time corresponding to the first unscheduled UL access window, and is valid for a duration of the first unscheduled UL access window.

### Example 80

The method of example 76, wherein the first parameter set and the second parameter set each include an arbitration inter-frame space number (AIFSN) parameter.

### Example 81

The method of example 80, wherein a value of 0 of the AIFSN parameter indicates that the second device is prevented from performing unscheduled UL access to the first device in the EDCA mode associated with the parameter set.

### Example 82

The method of example 76, wherein the first parameter set and the second parameter set each include a contention window minimum (CW MIN) parameter and a contention window maximum (CW MAX) parameter.

### Example 83

The method of example 76, wherein the first EDCA mode is a single-user (SU) EDCA mode and the second EDCA mode is a multiple-user (MU) EDCA mode.

### Example 84

The method of example 76, wherein the first EDCA mode is a single-user (SU) EDCA mode and the second EDCA mode is a trigger-based (TB) EDCA mode.

### Example 85

The method of example 76, wherein the first EDCA mode allows the second device to perform one or more EDCA timer countdowns for communication with the first device in accordance with the first parameter set, and wherein the second EDCA mode allows the second device to perform one or more EDCA timer countdowns for communication with the first device in accordance with the second parameter set.

### Example 86

The method of example 85, wherein the first EDCA mode or the second EDCA mode allows the second device to suspend the one or more associated EDCA timer countdowns.

### Example 87

The method of example 76, further comprising: transmitting, by the first device to the second device, information that enables or allows the second device to switch to using the first parameter set associated with the first EDCA mode when the second device is operating in the second unscheduled UL access window.

### Example 88

The method of example 87, wherein the information comprises a start time and an end time of a service period.

### Example 89

A method for wireless communication, comprising: transmitting, by a first device, a request to a second device to allow unscheduled uplink (UL) access by the first device to the second device, wherein the unscheduled UL access comprises allowance of at least one UL transmission from the first device to the second device that is not solicited by the second device; and receiving, by the first device, a first parameter set associated with a first enhanced distributed channel access (EDCA) mode and a second parameter set associated with a second EDCA mode, wherein the first parameter set comprises information indicative of a start time of a first unscheduled UL access window at which the first device is to use the first parameter set and the second parameter set comprises information indicative of a start time of a second unscheduled UL access window at which the first device is to use the second parameter set.

### Example 90

The method of example 89, wherein the first unscheduled UL access window is a period of time during which the first device uses one or more parameters from the first parameter set in the first EDCA mode, and wherein the second unscheduled UL access window is a period of time during which the first device uses one or more parameters from the second parameter set in the second EDCA mode.

### Example 91

The method of example 89, wherein the second parameter set comprises information indicative of a use timer, wherein the use timer specifies a time duration for the first device to use the second parameter associated with the second EDCA mode.

### Example 92

The method of example 89, wherein the second parameter set takes effect at the start time corresponding to the second unscheduled UL access window, and is valid for a duration of the second unscheduled UL access window, and wherein the first parameter set takes effect at the start time corresponding to the first unscheduled UL access window, and is valid for a duration of the first unscheduled UL access window.

### Example 93

The method of example 89, wherein the first parameter set and the second parameter set each include an arbitration inter-frame space number (AIFSN) parameter.

### Example 94

The method of example 93, wherein a value of 0 of the AIFSN parameter indicates that the first device is prevented from performing unscheduled UL access to the second device in the EDCA mode associated with the parameter set.

### Example 95

The method of example 89, wherein the first parameter set and the second parameter set each include a contention window minimum (CW MIN) parameter and a contention window maximum (CW MAX) parameter.

### Example 96

The method of example 89, wherein the first EDCA mode is a single-user (SU) EDCA mode and the second EDCA mode is a multiple-user (MU) EDCA mode.

### Example 97

The method of example 89, wherein the first EDCA mode is a single-user (SU) EDCA mode and the second EDCA mode is a trigger-based (TB) EDCA mode.

### Example 98

The method of example 89, wherein the first EDCA mode allows the first device to perform one or more EDCA timer countdowns for communication with the second device in accordance with the first parameter set, and wherein the second EDCA mode allows the first device to perform one or more EDCA timer countdowns for communication with the second device in accordance with the second parameter set.

### Example 99

The method of example 98, wherein the first EDCA mode or the second EDCA mode allows the first device to suspend the one or more associated EDCA timer countdowns.

### Example 100

The method of example 95, further comprising: receiving, by the first device from the second device, information that enables or allows the first device to switch to using the first parameter set associated with the first EDCA mode when the first device is operating in the second unscheduled UL access window.

### Example 101

The method of example 100, wherein the information comprises a start time and an end time of a service period.

### Example 102

A method comprising one or more techniques described in this disclosure.

### Example 103

A method comprising any combination of examples 1-102.

### Example 104

Any device described in this disclosure.

### Example 105

An apparatus for wireless communications, comprising: a memory; and at least one processor coupled to the memory and configured to: perform one or more techniques described in this disclosure.

### Example 106

An apparatus for wireless communications, comprising: a memory; and at least one processor coupled to the memory and configured to: perform the method of any of examples 1-103 or any combination of examples 1-103.

### Example 107

An apparatus comprising one or more means for performing one or more techniques described in this disclosure.

### Example 108

An apparatus comprising one or more means for performing the method of any of examples 1-103 or any combination of examples 1-103.

### Example 109

The apparatus of example 81 or 82, wherein the one or more means comprises one or more processors.

### Example 110

A tangible computer-readable medium storing non-transitory computer executable code, comprising code to: perform one or more techniques described in this disclosure.

### Example 111

A tangible computer-readable medium storing non-transitory computer executable code, comprising code to: perform the method of any of examples 1-103 or any combination of examples 1-103.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, such as a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (such as tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (such as RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

The claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A first device comprising:
at least one processing unit; and
at least one memory storing processor-executable code that, when executed by the at least one processing unit, is configured to cause the at least one processing unit to:
determine whether to allow unscheduled access to the first device by a second device; and
transmit, based on the determination, first information to the second device, wherein the first information includes:
a first indication indicative of whether the second device is allowed to transmit to the first device outside of a scheduled access period, or
a second indication indicative of whether the second device is allowed to transmit to the first device without first receiving a trigger.

2. The first device of claim 1, wherein the scheduled access period includes a target wake time (TWT) window.

3. The first device of claim 1, wherein:
the first indication indicative of whether the second device is allowed to transmit to the first device outside of the scheduled access period is indicative that the second device is allowed to transmit to the first device outside of the scheduled access period; and
the at least one processing unit is further configured to receive second information from the second device outside of the scheduled access period.

4. The first device of claim 1, wherein:
the first indication indicative of whether the second device is allowed to transmit to the first device outside of the scheduled access period is indicative that the second device is not allowed to transmit to the first device outside of the scheduled access period;
the second indication indicative of whether the second device is allowed to transmit to the first device without first receiving the trigger is indicative that the second device is allowed to transmit to the first device during the scheduled access period without first receiving the trigger; and
the at least one processing unit is further configured to receive, without transmission of a trigger, second information from the second device during the scheduled access period.

5. The first device of claim 1, wherein:
the first indication indicative of whether the second device is allowed to transmit to the first device outside of the scheduled access period is indicative that the second device is not allowed to transmit to the first device outside of the scheduled access period;
the second indication indicative of whether the second device is allowed to transmit to the first device without first receiving the trigger is indicative that the second device is not allowed to transmit to the first device during the scheduled access period without first receiving the trigger; and
the at least one processing unit is further configured to:
transmit a trigger to the second device; and
receive second information from the second device during the scheduled access period in response to the trigger.

6. The first device of claim 1, wherein to determine whether to allow unscheduled access to the first device by the second device, the code is further configured to cause the at least one processing unit to determine whether to allow unscheduled access to the first device by the second device on a first frequency band.

7. The first device of claim 6, wherein the code is further configured to cause the at least one processing unit to transmit the first information on a second frequency band different than the first frequency band.

8. A method for wireless communication, comprising:
determining, by a first device, whether to allow unscheduled access to the first device by a second device; and
transmitting, by the first device based on the determination, first information to the second device, wherein the first information includes:
a first indication indicative of whether the second device is allowed to transmit to the first device outside of a scheduled access period, or
a second indication indicative of whether the second device is allowed to transmit to the first device without first receiving a trigger.

9. The method of claim 8, wherein the scheduled access period includes a target wake time (TWT) window.

10. The method of claim 8, wherein:
the first indication indicative of whether the second device is allowed to transmit to the first device outside of the scheduled access period is indicative that the second device is allowed to transmit to the first device outside of the scheduled access period; and
the method further comprising receiving, by the first device, second information from the second device outside of the scheduled access period.

11. The method of claim 8, wherein:
the first indication indicative of whether the second device is allowed to transmit to the first device outside of the scheduled access period is indicative that the second device is not allowed to transmit to the first device outside of the scheduled access period;
the second indication indicative of whether the second device is allowed to transmit to the first device without first receiving the trigger is indicative that the second device is allowed to transmit to the first device during the scheduled access period without first receiving the trigger; and
the method further comprising receiving, by the first device without transmission of a trigger, second information from the second device during the scheduled access period.

12. The method of claim 8, wherein:
the first indication indicative of whether the second device is allowed to transmit to the first device outside of the scheduled access period is indicative that the second device is not allowed to transmit to the first device outside of the scheduled access period;
the second indication indicative of whether the second device is allowed to transmit to the first device without first receiving the trigger is indicative that the second device is not allowed to transmit to the first device during the scheduled access period without first receiving the trigger; and
the method further comprising:
transmitting, by the first device, a trigger to the second device; and
receiving, by the second device, second information from the second device during the scheduled access period in response to the trigger.

13. The method of claim 8, wherein determining whether to allow unscheduled access to the first device by the second device comprises determining whether to allow unscheduled access to the first device by the second device in a first frequency band.

14. The method of claim 13, wherein the method further comprises transmitting the first information in a second frequency band different than the first frequency band.

15. A first device, comprising:
at least one processing unit; and
at least one memory storing processor-executable code that, when executed by the at least one processing unit, is configured to cause the at least one processing unit to:
receive first information from a second device, wherein the first information includes: a first indication indicative of whether the first device is allowed to transmit to the second device outside of a scheduled access period, or a second indication indicative of whether the first device is allowed to transmit to the second device without first receiving a trigger from the second device; and
based on the first information:
transmit second information to the second device; or
refrain from transmitting the second information to the second device.

16. The first device of claim 15, wherein the scheduled access period includes a target wake time (TWT) window.

17. The first device of claim 15, wherein:
the first indication indicative of whether the first device is allowed to transmit to the second device outside of the scheduled access period is indicative that the first device is allowed to transmit to the second device outside of the scheduled access period; and
the at least one processing unit is further configured to transmit the second information to the second device outside of the scheduled access period.

18. The first device of claim 15, wherein:
the first indication indicative of whether the first device is allowed to transmit to the second device outside of the scheduled access period is indicative that the first device is not allowed to transmit to the second device outside of the scheduled access period;
the second indication indicative of whether the first device is allowed to transmit to the second device without first receiving the trigger is indicative of whether the first device is allowed to transmit to the second device during the scheduled access period without first receiving the trigger; and
the at least one processing unit is further configured to transmit, without first receiving a trigger, the second information to the second device during the scheduled access period.

19. The first device of claim 15, wherein:
the second indication indicative of whether the first device is allowed to transmit to the second device without first receiving the trigger is indicative that the first device is not allowed to transmit to the second device during the scheduled access period without first receiving the trigger; and
the at least one processing unit is further configured to:
receive a trigger from the second device; and
transmit the second information to the second device during the scheduled access period in response to the receiving the trigger.

20. The first device of claim 15, wherein:
the first indication indicative of whether the first device is allowed to transmit to the second device outside of the scheduled access period is indicative of whether the first device is allowed to transmit to the second device outside of the scheduled access period in a first frequency band; and
the code is configured to cause the at least one processing unit to transmit the second information in a second frequency band different than the first frequency band outside of the schedule access period.

21. The first device of claim 15, wherein:
the second indication indicative of whether the first device is allowed to transmit to the second device without first receiving the trigger from the second device is indicative of whether the first device is allowed to transmit to the second device in a first frequency band without first receiving a trigger from the second device; and
the code is configured to cause the at least one processing unit to transmit the second information in a second frequency band different than the first frequency band.

22. A method for wireless communication, comprising:
receiving, by a first device, first information from a second device, wherein the first information includes: a first indication indicative of whether the first device is allowed to transmit to the second device outside of a scheduled access period, or a second indication indicative of whether the first device is allowed to transmit to the second device without first receiving a trigger from the second device; and
based on the first information:
transmitting, by the first device, second information to the second device; or
refraining from transmitting, by the first device, the second information to the second device.

23. The method claim 22, wherein the scheduled access period includes a target wake time (TWT) window.

24. The method of claim 22, wherein:
the first indication indicative of whether the first device is allowed to transmit to the second device outside of the scheduled access period is indicative that the first device is allowed to transmit to the second device outside of the scheduled access period; and
the method further comprises transmitting, by the first device, the second information to the second device outside of the scheduled access period.

25. The method of claim 22, wherein:
the first indication indicative of whether the first device is allowed to transmit to the second device outside of the scheduled access period is indicative that the first device is not allowed to transmit to the second device outside of the scheduled access period;
the second indication indicative of whether the first device is allowed to transmit to the second device without first receiving the trigger is indicative of whether the first device is allowed to transmit to the second device during the scheduled access period without first receiving the trigger; and
the method further comprises transmitting, by the first device without first receiving a trigger, the second information to the second device during the scheduled access period.

26. The method of claim 22, wherein:
the second indication indicative of whether the first device is allowed to transmit to the second device without first receiving the trigger is indicative that the first device is not allowed to transmit to the second device during the scheduled access period without first receiving the trigger; and
the method further comprises:
receiving, by the first device, a trigger from the second device; and
transmitting, by the first device, the second information to the second device during the scheduled access period in response to the receiving the trigger.

27. The method of claim 22, wherein:
the first indication indicative of whether the first device is allowed to transmit to the second device outside of the scheduled access period is indicative of whether the first device is allowed to transmit to the second device outside of the scheduled access period in a first frequency band; and
the method further comprises transmitting, by the first device, the second information in a second frequency band different than the first frequency band outside of the schedule access period.

28. The method of claim 22, wherein:
the second indication indicative of whether the first device is allowed to transmit to the second device without first receiving the trigger from the second device is indicative of whether the first device is allowed to transmit to the second device in a first frequency band without first receiving a trigger from the second device; and
the method further comprises transmitting, by the first device, the second information in a second frequency band different than the first frequency band.
